(19) United States
(12) Patent Application Publication
(10) Pub. No.: US 2026/0246502 A1
(43) Pub. Date: Aug. 20, 2026

(54) CHANNEL STATE INFORMATION CODEBOOK ENHANCEMENTS

(71) Applicant: QUALCOMM Incorporated, San Diego, CA (US)

(72) Inventors: Kexin XIAO, Shanghai (CN); Yi HUANG, San Diego, CA (US); Hyojin LEE, San Diego, CA (US); Yu ZHANG, San Diego, CA (US); Runxin WANG, San Diego, CA (US)

(21) Appl. No.: 19/480,331

(22) PCT Filed: Jun. 15, 2023
(86) PCT No.: PCT/CN2023/100374

§ 371 Date: Oct. 30, 2025

(51) Int. Cl. H04B 7/0417; H04B 7/06

(52) U.S. Cl. CPC H04B 7/0417; H04B 7/0626

(57) ABSTRACT

Methods, systems, and devices for wireless communications are described. In wireless communications systems, a network entity may transmit channel state information (CSI) reference signals (CSI-RSs) to a user equipment (UE). The UE may perform measurements on the CSI-RS and generate a CSI report based on the CSI-RSs. The UE may transmit the CSI report to the network entity such that the network entity may identify suitable configurations for communication with the UE. Type I and Enhanced Type II CSI report codebooks may be extended to CSI-RSs transmitted using more than thirty-two ports. To account for the increase in the quantity of ports and the associated narrowing of CSI-RS beams, codebook parameters used to generate the CSI report at a UE may be adjusted.

### CROSS REFERENCE

This application is a 371 National Stage of PCT Application No. PCT/CN2023/100374, filed on Jun. 15, 2023, and assigned to the assignee hereof. The disclosure of the prior Application is considered part of and is incorporated by reference into this Patent Application.

### FIELD OF TECHNOLOGY

The following relates to wireless communications, including channel state information codebook enhancements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel state information (CSI) codebook enhancements. For example, the described techniques provide for extension of Type I and Enhanced Type II CSI report codebooks to CSI reference signals (CSI-RSs) transmitted using a quantity of antenna ports that exceeds a threshold (e.g., using more than thirty-two antenna ports). To account for an increase in the quantity of ports and the associated narrowing of CSI-RS beams, codebook parameters used to generate the CSI report at a user equipment (UE) may be adjusted.

A method for wireless communications at a UE is described. The method may include receiving, from a network entity, a set of CSI-RSs from a set of antenna ports at the network entity, generating a CSI report in accordance with a codebook, where a size of a downlink channel matrix estimated based on the set of CSI-RSs and used to generate the CSI report is based on a quantity of antenna ports that is included in the set of antenna ports, and where at least one parameter of the codebook is based on the quantity of antenna ports exceeding a threshold, and transmitting, to the network entity, the CSI report.

An apparatus for wireless communication is described. The apparatus may include memory, a transceiver, and at least one processor of a UE, the at least one processor coupled with the memory and the transceiver. The at least one processor may be configured to receive, from a network entity, a set of CSI-RSs from a set of antenna ports at the network entity, generate a CSI report in accordance with a codebook, where a size of a downlink channel matrix estimated based on the set of CSI-RSs and used to generate the CSI report is based on a quantity of antenna ports that is included in the set of antenna ports, and where at least one parameter of the codebook is based on the quantity of antenna ports exceeding a threshold, and transmit, to the network entity, the CSI report.

Another apparatus for wireless communications at a UE is described. The apparatus may include means for receiving, from a network entity, a set of CSI-RSs from a set of antenna ports at the network entity, means for generating a CSI report in accordance with a codebook, where a size of a downlink channel matrix estimated based on the set of CSI-RSs and used to generate the CSI report is based on a quantity of antenna ports that is included in the set of antenna ports, and where at least one parameter of the codebook is based on the quantity of antenna ports exceeding a threshold, and means for transmitting, to the network entity, the CSI report.

A non-transitory computer-readable medium storing code for wireless communications at a UE is described. The code may include instructions executable by a processor to receive, from a network entity, a set of CSI-RSs from a set of antenna ports at the network entity, generate a CSI report in accordance with a codebook, where a size of a downlink channel matrix estimated based on the set of CSI-RSs and used to generate the CSI report is based on a quantity of antenna ports that is included in the set of antenna ports, and where at least one parameter of the codebook is based on the quantity of antenna ports exceeding a threshold, and transmit, to the network entity, the CSI report.

In some examples of the method, apparatuses, and non-transitory computer-readable medium described herein, generating the CSI report in accordance with the codebook may include operations, features, means, or instructions for generating the CSI report in accordance with a Type I single-panel codebook.

In some examples of the method, apparatuses, and non-transitory computer-readable medium described herein, generating the CSI report in accordance with the Type I single-panel codebook may include operations, features, means, or instructions for generating the CSI report using a first spatial domain offset between layers of a precoding matrix, where the CSI report may be based on the precoding matrix, where the at least one parameter includes the first spatial domain offset, where a rank indication of the precoding matrix may be between two layers and eight layers, and where the first spatial domain offset may be larger than a second spatial domain offset associated with the quantity of antenna ports being at or below the threshold.

In some examples of the method, apparatuses, and non-transitory computer-readable medium described herein, generating the CSI report in accordance with the Type I single-panel codebook may include operations, features, means, or instructions for generating the CSI report using a spatial domain offset between layers of a precoding matrix, where the CSI report may be based on the precoding matrix, where the at least one parameter includes the spatial domain offset, where a rank indication of the precoding matrix may be between two layers and eight layers, and where a size of the spatial domain offset may be based on a configuration of horizontal antenna elements and vertical antenna elements used to transmit the set of CSI-RSs.

In some examples of the method, apparatuses, and non-transitory computer-readable medium described herein, generating the CSI report in accordance with the Type I single-panel codebook may include operations, features, means, or instructions for generating the CSI report using a first quantity of candidate spatial domain offsets between layers of a precoding matrix, where the CSI report may be based on the precoding matrix, where the at least one parameter includes the first quantity of candidate spatial domain offsets, where a rank indication of the precoding matrix may be between two layers and four layers, and where the first quantity of candidate spatial domain offsets may be larger than a second quantity of candidate spatial domain offsets associated with the quantity of antenna ports being at or below the threshold.

In some examples of the method, apparatuses, and non-transitory computer-readable medium described herein, generating the CSI report in accordance with the Type I single-panel codebook may include operations, features, means, or instructions for generating the CSI report using a first step size between beams of each beam group of a set of multiple beam groups associated with the Type I single-panel codebook, where the at least one parameter includes the first step size, and where the first step size may be larger than a second step size associated with the quantity of antenna ports being at or below the threshold.

In some examples of the method, apparatuses, and non-transitory computer-readable medium described herein, generating the CSI report in accordance with the Type I single-panel codebook may include operations, features, means, or instructions for generating the CSI report using a first quantity of beams within each of a set of multiple beam groups associated with the Type I single-panel codebook, where the at least one parameter includes the first quantity of beams, and where the first quantity of beams may be larger than a second quantity of beams width associated with the Type I single-panel codebook associated with the quantity of antenna ports being at or below the threshold.

In some examples of the method, apparatuses, and non-transitory computer-readable medium described herein, generating the CSI report in accordance with the Type I single-panel codebook may include operations, features, means, or instructions for generating the CSI report using an oversampling factor, where a size of the oversampling factor may be based on a rank of the CSI report, where the at least one parameter includes the size of the oversampling factor.

In some examples of the method, apparatuses, and non-transitory computer-readable medium described herein, generating the CSI report in accordance with the Type I single-panel codebook may include operations, features, means, or instructions for generating the CSI report based on a respective beam selection and a respective co-phasing selection for each sub-band of a set of multiple sub-bands of the set of CSI-RSs, where a rank indication of a precoding matrix may be between three layers and eight layers, where the CSI report may be based on the precoding matrix, and where the at least one parameter includes the respective beam selection and the respective co-phasing selection for each sub-band.

In some examples of the method, apparatuses, and non-transitory computer-readable medium described herein, generating the CSI report in accordance with the codebook may include operations, features, means, or instructions for generating the CSI report in accordance with a Type I multi-panel codebook.

In some examples of the method, apparatuses, and non-transitory computer-readable medium described herein, generating the CSI report in accordance with the Type I multi-panel codebook may include operations, features, means, or instructions for generating the CSI report using a first spatial domain offset between layers of a precoding matrix, where the CSI report may be based on the precoding matrix, where the at least one parameter includes the first spatial domain offset, where a rank indication of the precoding matrix may be three or four layers, and where the first spatial domain offset may be larger than a second spatial domain offset associated with the quantity of antenna ports being at or below the threshold.

In some examples of the method, apparatuses, and non-transitory computer-readable medium described herein, generating the CSI report in accordance with the Type I multi-panel codebook may include operations, features, means, or instructions for generating the CSI report using a first quantity of candidate spatial domain offsets between layers of a precoding matrix, where the CSI report may be based on the precoding matrix, where the at least one parameter includes the first quantity of candidate spatial domain offsets, where a rank indication of the precoding matrix may be between two layers and four layers, and where the first quantity of candidate spatial domain offsets may be larger than a second quantity of candidate spatial domain offsets associated with the quantity of antenna ports being at or below the threshold.

In some examples of the method, apparatuses, and non-transitory computer-readable medium described herein, generating the CSI report in accordance with the codebook may include operations, features, means, or instructions for generating the CSI report in accordance with an Enhanced Type II single-panel codebook.

In some examples of the method, apparatuses, and non-transitory computer-readable medium described herein, generating the CSI report in accordance with the Enhanced Type II single-panel codebook may include operations, features, means, or instructions for generating the CSI report using a first quantity of spatial domain bases, where the at least one parameter includes the first quantity of spatial domain bases, and where the first quantity of spatial domain bases may be larger than a second quantity of spatial domain bases associated with the quantity of antenna ports being at or below the threshold.

In some examples of the method, apparatuses, and non-transitory computer-readable medium described herein, generating the CSI report in accordance with the codebook may include operations, features, means, or instructions for generating the CSI report in accordance with an Enhanced Type II multi-panel codebook.

In some examples of the method, apparatuses, and non-transitory computer-readable medium described herein, generating the CSI report in accordance with the Enhanced Type II multi-panel codebook may include operations, features, means, or instructions for generating the CSI report using a same set of spatial domain bases for each panel of a set of multiple panels used to transmit the set of CSI-RSs.

In some examples of the method, apparatuses, and non-transitory computer-readable medium described herein, transmitting the CSI report may include operations, features, means, or instructions for transmitting the CSI report via an uplink control information (UCI), where an indication of the set of spatial domain bases are packed in group zero of part two of the UCI, where a set of non-zero coefficients for each layer are indicated in a group one or a group two of part two of the UCI, and where a quantity of non-zero coefficients of the set of non-zero coefficients for each layer is indicated in part one of the UCI.

In some examples of the method, apparatuses, and non-transitory computer-readable medium described herein, generating the CSI report in accordance with the Enhanced Type II multi-panel codebook may include operations, features, means, or instructions for generating the CSI report using a same set of spatial domain bases, a same set of frequency domain bases, and a different co-phasing value for each panel of a set of multiple panels used to transmit the set of CSI-RSs.

In some examples of the method, apparatuses, and non-transitory computer-readable medium described herein, transmitting the CSI report may include operations, features, means, or instructions for transmitting the CSI report via a UCI, wherein an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples of the method, apparatuses, and non-transitory computer-readable medium described herein, generating the CSI report in accordance with the Enhanced Type II multi-panel codebook may include operations, features, means, or instructions for generating the CSI report using a same set of non-zero coefficients for each panel of the set of multiple panels.

In some examples of the method, apparatuses, and non-transitory computer-readable medium described herein, transmitting the CSI report may include operations, features, means, or instructions for transmitting the CSI report via a UCI, wherein an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples of the method, apparatuses, and non-transitory computer-readable medium described herein, the threshold may be thirty-two antenna ports.

A method for wireless communications at a network entity is described. The method may include transmitting, to a UE, a set of CSI-RSs using a set of antenna ports and receiving, from the UE, a CSI report generated at the UE in accordance with a codebook, where a size of a downlink channel matrix indicated by the CSI report is based on a quantity of antenna ports that is included in the set of antenna ports used to transmit the set of CSI-RSs, and where at least one parameter of the codebook is based on the quantity of antenna ports exceeding a threshold.

An apparatus for wireless communication is described. The apparatus may include memory and at least one processor of a network entity, the at least one processor coupled with the memory. The at least one processor may be configured to transmit, to a UE, a set of CSI-RSs using a set of antenna ports and receive, from the UE, a CSI report generated at the UE in accordance with a codebook, where a size of a downlink channel matrix indicated by the CSI report is based on a quantity of antenna ports that is included in the set of antenna ports used to transmit the set of CSI-RSs, and where at least one parameter of the codebook is based on the quantity of antenna ports exceeding a threshold.

Another apparatus for wireless communications at a network entity is described. The apparatus may include means for transmitting, to a UE, a set of CSI-RSs using a set of antenna ports and means for receiving, from the UE, a CSI report generated at the UE in accordance with a codebook, where a size of a downlink channel matrix indicated by the CSI report is based on a quantity of antenna ports that is included in the set of antenna ports used to transmit the set of CSI-RSs, and where at least one parameter of the codebook is based on the quantity of antenna ports exceeding a threshold.

A non-transitory computer-readable medium storing code for wireless communications at a network entity is described. The code may include instructions executable by a processor to transmit, to a UE, a set of CSI-RSs using a set of antenna ports and receive, from the UE, a CSI report generated at the UE in accordance with a codebook, where a size of a downlink channel matrix indicated by the CSI report is based on a quantity of antenna ports that is included in the set of antenna ports used to transmit the set of CSI-RSs, and where at least one parameter of the codebook is based on the quantity of antenna ports exceeding a threshold.

In some examples of the method, apparatuses, and non-transitory computer-readable medium described herein, the codebook may be a Type I single-panel codebook.

In some examples of the method, apparatuses, and non-transitory computer-readable medium described herein, the at least one parameter includes a first spatial domain offset between layers of a precoding matrix, the CSI report may be based on the precoding matrix, a rank indication of the precoding matrix may be between two layers and eight layers, and the first spatial domain offset may be larger than a second spatial domain offset associated with the quantity of antenna ports being at or below the threshold.

In some examples of the method, apparatuses, and non-transitory computer-readable medium described herein, the at least one parameter includes a spatial domain offset between layers of a precoding matrix, the CSI report may be based on the precoding matrix, a rank indication of the precoding matrix may be between two layers and eight layers, and a size of the spatial domain offset may be based on a configuration of horizontal antenna elements and vertical antenna elements used to transmit the set of CSI-RSs.

In some examples of the method, apparatuses, and non-transitory computer-readable medium described herein, the at least one parameter includes a first quantity of candidate spatial domain offsets between layers of a precoding matrix, the CSI report may be based on the precoding matrix, a rank indication of the precoding matrix may be between two layers and four layers, and the first quantity of candidate spatial domain offsets may be larger than a second quantity of candidate spatial domain offsets associated with the quantity of antenna ports being at or below the threshold.

In some examples of the method, apparatuses, and non-transitory computer-readable medium described herein, the at least one parameter includes a first step size between beams of each beam group of a set of multiple beam groups associated with the Type I single-panel codebook and the first step size may be larger than a second step size associated with the quantity of antenna ports being at or below the threshold.

In some examples of the method, apparatuses, and non-transitory computer-readable medium described herein, the at least one parameter includes a first quantity of beams within each of a set of multiple beam groups associated with the Type I single-panel codebook and the first quantity of beams may be larger than a second quantity of beams width associated with the Type I single-panel codebook associated with the quantity of antenna ports being at or below the threshold.

In some examples of the method, apparatuses, and non-transitory computer-readable medium described herein, the at least one parameter includes an oversampling factor and a size of the oversampling factor may be based on a rank of the CSI report.

In some examples of the method, apparatuses, and non-transitory computer-readable medium described herein, the at least one parameter includes a respective beam selection and a respective co-phasing selection for each sub-band of a set of multiple sub-bands of the set of CSI-RSs, a rank indication of a precoding matrix may be between three layers and eight layers, and the CSI report may be based on the precoding matrix.

In some examples of the method, apparatuses, and non-transitory computer-readable medium described herein, the codebook may be a Type I multi-panel codebook.

In some examples of the method, apparatuses, and non-transitory computer-readable medium described herein, the at least one parameter includes a first spatial domain offset between layers of a precoding matrix, the CSI report may be based on the precoding matrix, a rank indication of the precoding matrix may be three or four layers, and the first spatial domain offset may be larger than a second spatial domain offset associated with the quantity of antenna ports being at or below the threshold.

In some examples of the method, apparatuses, and non-transitory computer-readable medium described herein, the at least one parameter includes a first quantity of candidate spatial domain offsets between layers of a precoding matrix, the at least one parameter includes a first quantity of candidate spatial domain offsets between layers of a precoding matrix, the CSI report may be based on the precoding matrix, a rank indication of the precoding matrix may be between two layers and four layers, and the first quantity of candidate spatial domain offsets may be larger than a second quantity of candidate spatial domain offsets associated with the quantity of antenna ports being at or below the threshold.

In some examples of the method, apparatuses, and non-transitory computer-readable medium described herein, the codebook may be an Enhanced Type II single-panel codebook.

In some examples of the method, apparatuses, and non-transitory computer-readable medium described herein, the at least one parameter includes a first quantity of spatial domain bases and the first quantity of spatial domain bases may be larger than a second quantity of spatial domain bases associated with the quantity of antenna ports being at or below the threshold.

In some examples of the method, apparatuses, and non-transitory computer-readable medium described herein, the codebook may be an Enhanced Type II multi-panel codebook.

In some examples of the method, apparatuses, and non-transitory computer-readable medium described herein, the at least one parameter includes use of a same set of spatial domain bases for each panel of a set of multiple panels used to transmit the set of CSI-RSs.

In some examples of the method, apparatuses, and non-transitory computer-readable medium described herein, the CSI report is received via a UCI, where an indication of the set of spatial domain bases are packed in group zero of part two of the UCI, where a set of non-zero coefficients for each layer are indicated in a group one or a group two of part two of the UCI, and where a quantity of non-zero coefficients of the set of non-zero coefficients for each layer is indicated in part one of the UCI.

In some examples of the method, apparatuses, and non-transitory computer-readable medium described herein, the at least one parameter includes use of a same set of spatial domain bases, a same set of frequency domain bases, and a different co-phasing value for each panel of a set of multiple panels used to transmit the set of CSI-RSs.

In some examples of the method, apparatuses, and non-transitory computer-readable medium described herein, the CSI report is received via a UCI, where an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples of the method, apparatuses, and non-transitory computer-readable medium described herein, the at least one parameter includes use of a same set of non-zero coefficients for each panel of the set of multiple panels.

In some examples of the method, apparatuses, and non-transitory computer-readable medium described herein, the CSI report is received via a UCI, where an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples of the method, apparatuses, and non-transitory computer-readable medium described herein, the threshold may be thirty-two antenna ports.

### BRIEF DESCRIPTION OF THE DRAWINGS

FIG. 1 shows an example of a wireless communications system that supports channel state information codebook enhancements in accordance with one or more aspects of the present disclosure.

FIG. 2 shows an example of precoding matrices indicated in a CSI report generated using an Enhanced Type II codebook that supports channel state information codebook enhancements in accordance with one or more aspects of the present disclosure.

FIG. 3 shows an example of a wireless communications system that supports channel state information codebook enhancements in accordance with one or more aspects of the present disclosure.

FIG. 4 shows an example of a beam configuration that supports channel state information codebook enhancements in accordance with one or more aspects of the present disclosure.

FIG. 5 shows an example of an uplink control information packing scheme that supports channel state information codebook enhancements in accordance with one or more aspects of the present disclosure.

FIG. 6 shows an example of a process flow that supports channel state information codebook enhancements in accordance with one or more aspects of the present disclosure.

FIGS. 7 and 8 show block diagrams of devices that support channel state information codebook enhancements in accordance with one or more aspects of the present disclosure.

FIG. 9 shows a block diagram of a communications manager that supports channel state information codebook enhancements in accordance with one or more aspects of the present disclosure.

FIG. 10 shows a diagram of a system including a device that supports channel state information codebook enhancements in accordance with one or more aspects of the present disclosure.

FIGS. 11 and 12 show block diagrams of devices that support channel state information codebook enhancements in accordance with one or more aspects of the present disclosure.

FIG. 13 shows a block diagram of a communications manager that supports channel state information codebook enhancements in accordance with one or more aspects of the present disclosure.

FIG. 14 shows a diagram of a system including a device that supports channel state information codebook enhancements in accordance with one or more aspects of the present disclosure.

FIGS. 15 and 16 show flowcharts illustrating methods that support channel state information codebook enhancements in accordance with one or more aspects of the present disclosure.

### DETAILED DESCRIPTION

In wireless communications systems, a network entity may transmit channel state information (CSI) reference signals (CSI-RSs) to a user equipment (UE). The UE may perform measurements on the CSI-RS and may generate a CSI report based on the measurements of the CSI-RSs. The UE may transmit the CSI report to the network entity such that the network entity may identify suitable configurations for communications with the UE. The network entity uses a quantity of antenna ports (e.g., up to 32 antenna ports) to transmit the CSI-RS. Different codebooks for generating the CSI report at the UE are currently defined, including a Type I codebook, a Type II codebook, and an Enhanced Type (eType) II codebook. Type I and Type II codebooks are different in that Type I codebooks select a beam from a group of beams, whereas Type II codebooks select a group of beams and linearly combine the beams within the group. Type II codebooks are often used for multi-user multiple-input multiple-output (MIMO) applications, while Type I codebooks are often used for single user MIMO cases. Type II codebooks may support up to rank 2 (i.e., 2 layers), and eType II codebooks extend the Type II codebook to rank 4 (i.e., 4 layers). The use of more CSI ports at the network entity allows for smaller beams, and therefore more accurate channel estimation and more precise beam selection. Currently CSI codebooks may support up to 32 antenna ports.

Type I and eType II codebooks may be extended to apply to CSI-RSs using more than a threshold quantity of antenna ports (e.g., using more than 32 antenna ports, for example 64 or 128 antenna ports). To account for an increase in the quantity of ports and the associated narrowing of CSI-RS beams, codebook parameters used to generate the CSI report at the UE may be adjusted. For example, for a Type I codebook, parameters such as the beam width used to generate the CSI report, the quantity of beams, the oversampling rates, and the spatial domain offsets between beams may be adjusted to account for the increase in the quantity of antenna ports and the associated narrowing of CSI-RS beams. For an eType II codebook, the quantity of spatial domain bases may be increased to account for the narrowed beam width with the increased quantity of ports. With an increase in the quantity of CSI ports, the eType II codebook may also be extended to a multi antenna panel scenario, as more CSI ports are available to support the multiple antenna panels.

Aspects of the disclosure are initially described in the context of wireless communications systems. Aspects of the disclosure are further illustrated by and described with reference to precoding matrices, beam configurations, uplink control information (UCI) packing schemes, process flows, apparatus diagrams, system diagrams, and flowcharts that relate to channel state information codebook enhancements.

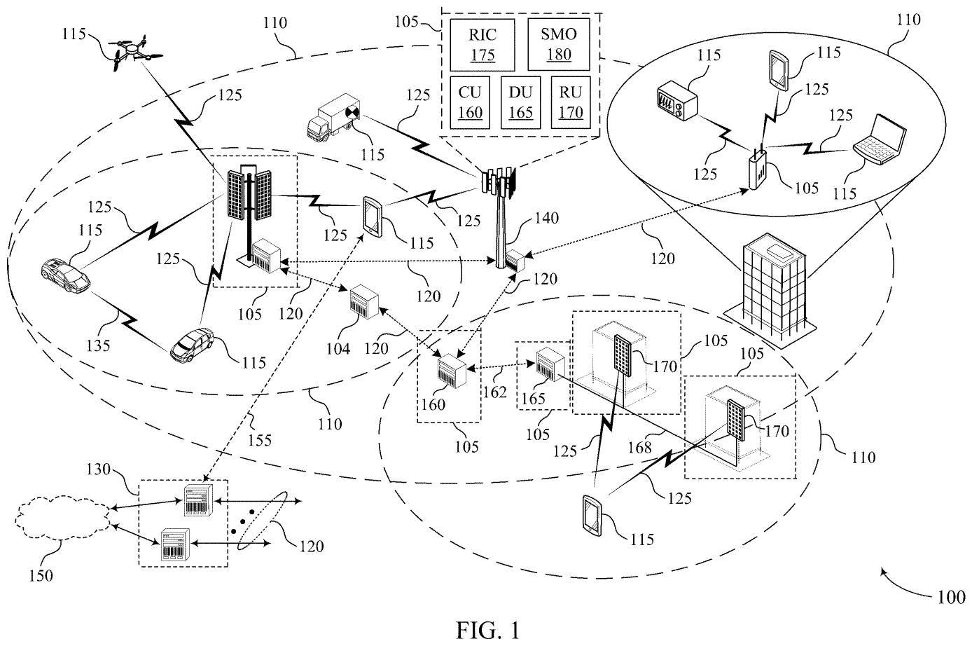

FIG. 1 shows an example of a wireless communications system 100 that supports channel state information codebook enhancements in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support channel state information codebook enhancements as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A network entity 105 may transmit CSI-RSs to a UE 115, and the UE 115 may perform measurements on the CSI-RS and may generate a CSI report based on the CSI-RSs. The UE 115 may transmit the CSI report to the network entity 105 such that the network entity 105 may identify suitable configurations for communications with the UE 115. The network entity 105 uses a quantity of antenna ports (e.g., up to 32 antenna ports) to transmit the CSI-RS. Different codebooks for generating the CSI report at the UE are currently defined, including a Type I codebook, a Type II codebook, and an eType II codebook. Type I and Type II codebooks are different in that Type I codebooks select a beam from a group of beams, whereas Type II codebooks select a group of beams and linearly combine the beams within the group. Type I codebooks may be regarded as a basic model, which may be further used to construct Type II and eType II codebooks.

For each type of CSI codebook, the UE 115 may estimate an Mᵣ×Mₜ downlink channel matrix H based on Mₜ-port CSI-RS, where Mₜ refers to the quantity of antenna ports used by the network entity 105 to transmit the CSI-RSs, and Mᵣ refers to the quantity of antenna ports used by the UE 115 to receive the CSI-RSs. The network entity 105 may indicate to the UE 115, for example in RRC signaling, a codebook type and one or more codebook parameters to use in generation of the CSI report. For example, an RRC information element CSI-ReportConfig may indicate the antenna ports indices, P, which are used for each layer from rank 1 to rank R (e.g., {{P₁(0), . . . , P₁(L₁−1)}, . . . , {P_{R}(0), . . . , P_{R}(L_{R}−1)}}. The UE 115 may determine the rank r* and the precoding matrix index for a given codebook, as (r*, i*)=argmax_{r,i} SEₑₛₜ(H, Pᵣ(i)). SEₑₛₜ(H, Pᵣ(i)) refers to the spectral efficiency estimation when H and Pᵣ(i) are given, r* refers to an optimal rank, and P_{r*}(i*) refers to an optimal precoder. The UE 115 may calculate the channel quality index (CQI) as CQI*=f(SEₑₛₜ(H,P_{r*}(i*))). The CSI report may include a rank indicator (RI), a PMI, and/or a CQI calculated using the indicated codebook type for the indicated quantity of CSI antenna ports, Mₜ.

The use of more CSI ports at the network entity 105 allows for smaller beams, and therefore more accurate channel estimation and more precise beam selection. Current CSI codebooks may support up to 32 antenna ports. For example, Table 1 shows current quantities of antenna ports and layers that may be used for different CSI codebooks types.

TABLE 1

| | Maximum | |
|---|---|---|
| | Quantity of CSI | Maximum Quantity of |
| Codebook Type | Antenna Ports | Layers |
| Type I Single-Panel | 32 | 8 |
| Codebook | | |
| Type I Multi-Panel | 32 | 4 |
| Codebook | | |
| Type II Codebook- | 32 | 2 |
| single-panel | | |
| Type II Port Selection | 32 | 2 |
| Codebook | | |
| eType II Codebook | 32 | 4 |
| eType II Port Selection | 32 | 4 |
| Codebook | | |
| Further eType II port | 32 | 4 |
| selection codebook | | |

Type I and eType II codebooks may be extended to apply to CSI-RSs using more than 32 antenna ports, for example 64 or 128 antenna ports. For Type II codebooks for coherent joint transmission (CJT) from multiple transmission reception points (TRPs), as different CSI-RSs may be transmitted by distributed TRPs (e.g., different locations and/or different boresights), the spatial domain bases and frequency domain bases may be selected independently by the UE 115. Thus, directly reusing the parameters for eType II codebook for CJT may cause CSI overhead for the case of single CSI-RS with more than 32 antenna ports. When more than 32 antenna ports are used for CSI-RS transmission, ports within a single CSI-RS may be co-located in a single panel or in multi-panel.

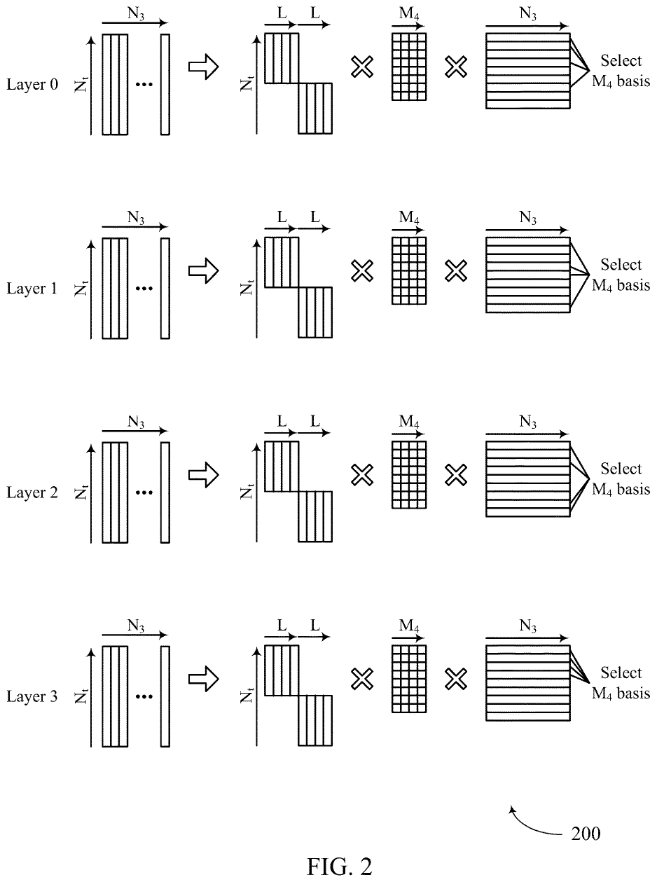

FIG. 2 shows an example of a precoding matrices indicated in a CSI report generated using an eType II codebook 200 that supports channel state information codebook enhancements in accordance with one or more aspects of the present disclosure. For an eType II codebook, a UE 115 may indicate precoding matrices for each of the multiple layers in a CSI report, and the CSI report may support up to a rank of four (i.e., four layers). For each layer, the precoder across a number of N₃ PMI subbands may be an Nₜ×N₃ matrix W (e.g., W=W₁×\tilde{W}₂×W).

Spatial domain bases W₁ (e.g., DFT bases) in the matrix may be an Nₜ×2L matrix, where Nₜ may refer to a number of transmit antennas and L may refer to a number of beams. W₁ may be layer-common, Nₜ may be RRC configured (e.g., Nₜ=2N₁O₁N₂O₂, with O₁ and O₂ oversampling), and L may be RRC configured (e.g., L={2,4,6}).

Frequency domain bases W_{f} (e.g., DFT bases) may be an M×N₃ matrix, where M may refer to a number or quantity of frequency domain bases. M may be rank-pair specific (e.g., M₁=M₂ for rank={1,2}, and M₃=M₄ for rank={3,4}, where M₁ or M₃ is RRC configured).

Coefficients \tilde{W}₂ may be a 2L×M matrix and may be layer-specific. For each layer, a UE 115 may report up to K₀ non-zero coefficients (NZCs), where K₀ is RRC configured. Across all layers, the UE 115 may report up to 2K₀ non-zero coefficients. Unreported coefficients may be set to zeros, and the UE 115 may quantize the \tilde{W}₂ coefficients before reporting.

For a layer l, a UE 115 may quantize NZCs of \tilde{W}_{2,l} (e.g., layer-independent quantization). The NZCs may be reported for two different polarizations for transmissions from a TRP. Equation 1 shows an example of a matrix of coefficients \tilde{W}₂ (e.g., quantization of \tilde{W}₂ for Type-II CSI).

$$[ \begin{matrix}{p}_{ref} {p}_{0 , 0} {e}^{j {ϕ}_{0 , 0}} & {p}_{ref} {p}_{0 , 1} {e}^{j {ϕ}_{0 , 1}} & … & {p}_{ref} {p}_{0 , M - 1} {e}^{j {ϕ}_{0 , M - 1}} \\ {p}_{ref} {p}_{0 , 0} {e}^{j {ϕ}_{1 , 0}} & {p}_{ref} {p}_{0 , 0} {e}^{j {ϕ}_{1 , 1}} & … & {p}_{ref} {p}_{1 , M - 1} {e}^{j {ϕ}_{1 , M - 1}} \\ ⋮ & ⋮ & ⋱ & ⋮ \\ {p}_{ref} {p}_{L - 1 , 0} {e}^{j {ϕ}_{L - 1 , 0}} & {p}_{ref} {p}_{L - 1 , 1} {e}^{j {ϕ}_{L - 1 , 1}} & … & {p}_{ref} {p}_{L - 1 , M - 1} {e}^{j {ϕ}_{L - 1 , M - 1}} \\ 1 & {p}_{L , 1} {e}^{j {ϕ}_{L , 1}} & … & {p}_{L , M - 1} {e}^{j {ϕ}_{L , M - 1}} \\ {p}_{L + 1 , 0} {e}^{j {ϕ}_{L + 1 , 0}} & {p}_{L + 1 , 1} {e}^{j {ϕ}_{L + 1 , 1}} & … & {p}_{L + 1 , M - 1} {e}^{j {ϕ}_{L + 1 , M - 1}} \\ ⋮ & ⋮ & ⋱ & ⋮ \\ {p}_{2 L - 1 , 0} {e}^{j {ϕ}_{2 L - 1 , 0}} & {p}_{2 L , 1 , 1} {e}^{j {ϕ}_{2 L - 1 , 1}} & … & {p}_{2 L - 1 , M - 1} {e}^{j {ϕ}_{2 L - 1 , M - 1}}\end{matrix} ] \qquad ( 1 )$$

At a first step, the UE 115 may report an index of a strongest coefficient (e.g., NZC), and the strongest coefficient may be used as a reference for a stronger polarization. The stronger polarization may refer to a polarization associated with the strongest coefficient, and the weaker polarization may be the other polarization. If the strongest coefficient is one, the UE 115 may not quantize the coefficient. For example, the strongest coefficient in Equation 1 is the “1” in the first column. The strongest coefficient may be used as a reference for the stronger polarization. The UE 115 may also report a reference power for a weaker polarization. At a second step, the UE 115 may quantize the reference power for the weaker polarization with four bits from 0 dB with a −1.5 dB (in power) step size. The UE 115 may also report a differential amplitude for each coefficient. The UE 115 may quantize the differential amplitude with three bits from 0 dB with a −3 dB (in power) step size. The UE 115 may also report a phase quantization for each coefficient. The UE 115 may quantize the phase with a 16 phase shift keying (PSK) alphabet.

The number of spatial domain bases, frequency domain basis, and NZCs to be reported by a UE 115 may be given by Table 2.

TABLE 2

pᵥ

| paramCombination | L | v ∈ {1, 2} | v ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ¼ | ¼ | ½ |
| 7 | 6 | ¼ | — | ½ |
| 8 | 6 | ¼ | — | ¾ |

For a quantity of spatial domain bases, L={2, 4, 6}. For a quantity of frequency domain bases

$${M}_{1} = {M}_{2} = ⌈ {p}_{1} \times \frac{{N}_{3}}{R} ⌉ and {M}_{3} = {M}_{4} = ⌈ {p}_{3} \times \frac{{N}_{3}}{R} ⌉ .$$

For a quantity of NZCs, K₀=[β×2LM₁]. A UE 115 may receive RRC signaling to configure a (e.g., 1 out of 8) combination of L, p₁, p₃, β.

For CJT multi TRP (mTRP) applications, a UE 115 may support two modes of operation. The two modes may share commonality in detailed designs such as parameter combinations, basis selections, TRP (or TRP group) selection, reference amplitude, or W₂ quantization schemes. In a first mode of operation, the UE 115 may support per-TRP or per-TRP-group spatial domain and/or frequency domain basis selection, which allows independent frequency domain basis selection across N TRPs or TRP groups. An example formulation, where Nis equal to the quantity of TRPs or TRP groups is given by

$$\begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} .$$

In a second mode of operation, the UE 115 may support per-TRP or per-TRP-group spatial domain basis selection and common or joint (across N TRPs) frequency domain basis selection. An example formulation, where Nis equal to the quantity of TRPs or TRP groups is given by

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] .$$

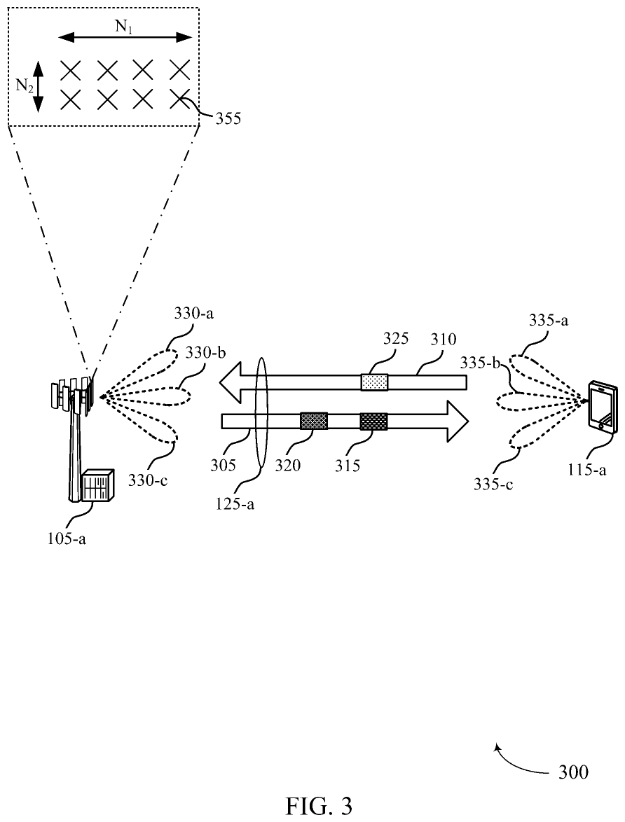

FIG. 3 shows an example of a wireless communications system 300 that supports channel state information codebook enhancements in accordance with one or more aspects of the present disclosure. The wireless communications system 300 may implement or may be implemented by aspects of the wireless communications system 100. For example, the wireless communications system 300 may include a UE 115-a, which may be an example of a UE 115 as described herein. The wireless communications system 300 may include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include a bi-directional link that enable both uplink and downlink communications. For example, the UE 115-a may transmit uplink signals 305 (e.g., uplink transmissions), such as uplink control signals or uplink data signals, to the network entity 105-a using the communication link 125-a and the network entity 105-a may transmit downlink signals 310 (e.g., downlink transmissions), such as downlink control signals or downlink data signals, to the UE 115-a using the communication link 125-a.

As described herein, the network entity 105-a may transmit control signaling 315 that schedules CSI-RSs 320 and configures a CSI report codebook and parameters for the CSI report. The UE 115-a may measure the CSI-RSs 320 and generate a CSI report based on the CSI-RSs. The UE may transmit the CSI report 325 to the network entity 105-a such that the network entity 105-a may identify suitable configurations for communications with the UE (e.g., for communication of downlink signals 310 such as physical downlink control channels (PDCCHs) and physical downlink shared channels (PDSCHs)). The network entity 105-a uses a quantity of antenna ports 355 to transmit the CSI-RSs 320. The network entity 105-a may use beamforming techniques to transmit the CSI-RSs 320 via a quantity of beams 330 (e.g., a beam 330-a, a beam 330-b, and a beam 330-c as shown in FIG. 3) using the quantity of antenna ports 355. The UE 115-a may receive the CSI-RSs via a quantity of receive beams 335 (e.g., a beam 335-a, a beam 335-b, and a beam 335-c as shown in FIG. 3) at the UE 115-a. As shown, the network entity 105-a may use an antenna array that includes N₁ antenna ports 355 in the horizontal direction and N₂ antenna ports 355 in the vertical direction.

A Type I codebook may define precoding vectors generated by the Kronecker product of horizontal and vertical DFT vectors (e.g., N₁O₁ horizontal DFT vectors and N₂O₂ DFT vertical vectors). O₁ may refer to the oversampling factor in the horizontal domain, and O₂ may refer to the oversampling factor in the vertical domain. The Type I codebook may use a W₁W₂ codebook structure, where W₁ is used for beam group selection and W₂ is used for beam selection and co-phasing between different poles. For rank-1, closely spaced horizontal and vertical DFT vectors may be selected for W₁. For higher ranks, orthogonal pairs of horizontal and vertical DFT vectors may be selected for W₁. Rank 3-4 codebooks for more than 8 antenna ports 355 may adopt a double co-phasing structure. For a Type I single panel codebook, example configurations of quantities of ports, and possible configurations for (N₁, N₂) and (O₁, O₂) are shown in Table 3. For a Type I multi-panel codebook, example configurations of quantities of ports, and possible configurations for (N_{g}, N₁, N₂) and (O₁, O₂) are shown in Table 4, where N_{g} refers to the quantity of panels.

TABLE 3

| Quantity of Ports | (N₁, N₂) | (O₁, O₂) |
|---|---|---|
| 4 | (2, 1) | (4, 1) |
| 8 | (2, 2) | (4, 4) |
| | (4, 1) | (4, 1) |
| 12 | (2, 3) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |
| 64 | (8, 4) | (4, 4) |
| | (16, 2) | (4, 4) |
| | (32, 1) | (4, 1) |
| 128 | (8, 8) | (4, 4) |
| | (16, 4) | (4, 4) |
| | (32, 2) | (4, 4) |
| | (64, 1) | (4, 1) |

TABLE 4

| Quantity of ports | | |
|---|---|---|
| (P) | (N_{g}, N₁, N₂) | (O₁, O₂) |
| 8 | (2, 2, 1) | (4, 1) |
| 16 | (2, 4, 1) | (4, 1) |
| | (4, 2, 1) | (4, 1) |
| | (2, 2, 2) | (4, 4) |
| 32 | (2, 8, 1) | (4, 1) |
| | (4, 4, 1) | (4, 1) |
| | (2, 4, 2) | (4, 4) |
| | (4, 2, 2) | (4, 4) |
| 64 | (2, 16, 1) | (4, 1) |
| | (2, 8, 2) | (4, 4) |
| | (2, 4, 4) | (4, 4) |
| | (4, 8, 1) | (4, 1) |
| | (4, 4, 2) | (4, 4) |
| 128 | (2, 32, 1) | (4, 1) |
| | (2, 16, 2) | (4, 4) |
| | (2, 8, 4) | (4, 1) |
| | (4, 16, 1) | (4, 4) |
| | (4, 8, 2) | (4, 4) |
| | (4, 4, 4) | (4, 4) |

For a Type I single panel codebook, component beamforming vectors may be calculated as v_{l,m}=xₗ⊗uₘ and \tilde{v}_{l,m}=xₗ⊗uₘ,

$${x}_{l} = {[ {e}^{\frac{j 2 π l}{{O}_{1} {N}_{1}}} … {e}^{\frac{j 2 π l ( {N}_{1} - 1 )}{{O}_{1} {N}_{1}}} ]}^{T} , {\tilde{x}}_{l} = {[ {e}^{\frac{j 4 π l}{{O}_{1} {N}_{1}}} … {e}^{\frac{j 4 π l ( {N}_{1} / 2 - 1 )}{{O}_{1} {N}_{1}}} ]}^{T} , and$$

$${u}_{m} = {[ {e}^{\frac{j 2 π m}{{O}_{2} {N}_{2}}} … {e}^{\frac{j 2 π m ( {N}_{2} - 1 )}{{O}_{2} {N}_{2}}} ]}^{T} ,$$

where l=0, 1, . . . , N₁*O₁ and m=0, 1, . . . , N₂*O₂. Co-phasing factors may be given by φₙ=e^{jπn/2} and θₚ=e^{jπp/4}. l=0, 1, . . . , N1*O1″. The UE 115-a uses the field i_{1,1} in the CSI report to indicate a chosen value of l, and the chosen horizontal beam xₗ may be determined based on the value of l. The UE 115-a uses the field i_{1,2} to indicate the chosen value of m, and the chosen horizontal beam uₘ may be determined based on the value of m. T refers to the transpose operator.

For a Type I multi panel codebook, component beamforming vectors may be calculated as v_{l,m}=xₗ⊗uₘ, where

$${x}_{l} = {[ 1 {e}^{\frac{j 2 π l}{{O}_{1} {N}_{1}}} … {e}^{\frac{j 2 π l ( {N}_{1} - 1 )}{{O}_{1} {N}_{1}}} ]}^{T} and {u}_{m} = {[ 1 , {e}^{\frac{j 2 π m}{{O}_{2} {N}_{2}}} … {e}^{\frac{j 2 π m {N}_{2} - 1 )}{{O}_{2} {N}_{2}}} ]}^{T} .$$

Co-phasing factors may be given by φₙ=e^{jπn/2}, aₚ=e^{jπ/4} e^{jπp/2}, and bₙ=e^{-jπ/4} e^{jπn/2}. For example, for a Type I single panel codebook, the co-phasing factor On may be used to construct the full precoding matrix (e.g., by multiplying the beam vector corresponding to the ports of the second polarization).

For a mode 1 multi panel Type I codebook (e.g., for N_{g}∈{2, 4}) co-phasing for cross polarized antennas (XPOL) and for the different panels may be given by

$${W}_{l , m , p , n}^{1 , 2 , 1} = \frac{1}{\sqrt{P}} [ \begin{matrix}[ \begin{matrix}{v}_{l , m} \\ {φ}_{n} {v}_{l , m}\end{matrix} ] \\ {φ}_{{p}_{1}} [ \begin{matrix}{v}_{l , m} \\ {φ}_{n} {v}_{l , m}\end{matrix} ]\end{matrix} ] , {W}_{l , m , p , n}^{2 , 2 , 1} = \frac{1}{\sqrt{P}} [ \begin{matrix}[ \begin{matrix}{v}_{l , m} \\ - {φ}_{n} {v}_{l , m}\end{matrix} ] \\ {φ}_{{p}_{1}} [ \begin{matrix}{v}_{l , m} \\ - {φ}_{n} {v}_{l , m}\end{matrix} ]\end{matrix} ] ,$$

$${W}_{l , m , p , n}^{1 , 4 , 1} = \frac{1}{\sqrt{P}} [ \begin{matrix}[ \begin{matrix}{v}_{l , m} \\ {φ}_{n} {v}_{l , m}\end{matrix} ] \\ {φ}_{{p}_{1}} [ \begin{matrix}{v}_{l , m} \\ {φ}_{n} {v}_{l , m}\end{matrix} ] \\ {φ}_{{p}_{2}} [ \begin{matrix}{v}_{l , m} \\ {φ}_{n} {v}_{l , m}\end{matrix} ] \\ {φ}_{{p}_{3}} [ \begin{matrix}{v}_{l , m} \\ {φ}_{n} {v}_{l , m}\end{matrix} ]\end{matrix} ] , and {W}_{l , m , p , n}^{2 , 4 , 1} = \frac{1}{\sqrt{P}} [ \begin{matrix}[ \begin{matrix}{v}_{l , m} \\ - {φ}_{n} {v}_{l , m}\end{matrix} ] \\ {φ}_{{p}_{1}} [ \begin{matrix}{v}_{l , m} \\ - {φ}_{n} {v}_{l , m}\end{matrix} ] \\ {φ}_{{p}_{2}} [ \begin{matrix}{v}_{l , m} \\ - {φ}_{n} {v}_{l , m}\end{matrix} ] \\ {φ}_{{p}_{3}} [ \begin{matrix}{v}_{l , m} \\ - {φ}_{n} {v}_{l , m}\end{matrix} ]\end{matrix} ] .$$

For a mode 2 multi panel Type I codebook (e.g., for N_{g}∈{2}) co-phasing for XPOL and for the different panels may be given by

$${W}_{l , m , p , n}^{1 , 2 , 2} = \frac{1}{\sqrt{P}} [ \begin{matrix}[ \begin{matrix}{v}_{l , m} \\ {φ}_{{n}_{0}} {v}_{l , m}\end{matrix} ] \\ [ \begin{matrix}{a}_{{p}_{1}} {b}_{{n}_{1}} {v}_{l , m} \\ {a}_{{p}_{2}} {b}_{{n}_{2}} {v}_{l , m}\end{matrix} ]\end{matrix} ] and {W}_{l , m , p , n}^{2 , 2 , 2} = \frac{1}{\sqrt{P}} [ \begin{matrix}[ \begin{matrix}{v}_{l , m} \\ - {φ}_{{n}_{0}} {v}_{l , m}\end{matrix} ] \\ [ \begin{matrix}{a}_{{p}_{1}} {b}_{{n}_{1}} {v}_{l , m} \\ - {a}_{{p}_{2}} {b}_{{n}_{2}} {v}_{l , m}\end{matrix} ]\end{matrix} ] ,$$

where aₚ=e^{jπ/4} e^{jπ/2} and bₙ=e^{-jπ/4} e^{jπn/2}. The UE 115-a may use i_{1,4} and i₂ in the CSI report to indicate the value of p and n,

As described herein, use of more antenna ports 355 at the network entity 105-a for transmission of CSI-RSs 320 allows for smaller beams 330. Therefore, in some examples, the spatial domain offset among different layers for rank 2 to rank 8 Type I codebooks may be scaled based on the narrower beam width when more antenna ports 355 at the network entity 105-a are used for transmission of CSI-RSs 320.

For example, for rank 2 to rank 4 codebooks, for a single panel Type I codebook, an additional spatial domain offset candidate table may be used when more than 32 antenna ports 355 are used. In some examples, 4 spatial domain offset candidates may be used among layers, but the spatial domain offsets may be larger (e.g., scaled up). In some examples, the quantity of candidate spatial domain offset values may be increased (e.g., i_{1,3}∈{0, 1, 2, 3, 4, 5, 6, 7}. The UE 115-a may use the field i_{1,3} in the CSI report to indicate which beam offset candidate is selected. In some examples, for different configurations of (N₁, N₂), the quantities of candidate offset values may be different. In some examples, for rank 5 to rank 8 single panel Type I codebooks, the fixed spatial domain offsets among different layers may be scaled depending on the configuration of (N₁, N₂). For example, Table 5 shows i_{1,3} offset values for different N₁ and N₂ configurations for a rank 2 single panel Type I codebook, Table 6 shows i_{1,3} offset values for different N₁ and N₂ configurations for a rank 3 single panel Type I codebook, and Table 7 shows i_{1,3} offset values for different N₁ and N₂ configurations for a rank 4 single panel Type I codebook. A rank 2 single panel Type I codebook may support both mode 1 and mode 2 and may keep the legacy DFT structure. A rank 3 or rank 4 single panel Type I codebook may support single codebook mode, may keep the legacy DFT structure, and may not use a double co-phasing structure.

TABLE 5

| | N₁ ≥ N₂ > 16 | N₁ > 16 ≥ N₂ > 1 | 16 ≥ N₁ ≥ N₂ > 1 | N₁ > 16, N₂ = 1 |
|---|---|---|---|---|
| i₁₃ = 0 | (k₁, k₂) = | (k₁, k₂) = | (k₁, k₂) = | (k₁, k₂) = |
| i₁₃ = 1 | (0, 0) | (0, 0) | (0, 0) | (0, 0) |
| i₁₃ = 2 | (k₁, k₂) = | (k₁, k₂) = | (k₁, k₂) = | (k₁, k₂) = |
| i₁₃ = 3 | (2O₁, 0) | (2O₁, 0) | (O₁, 0) | (2O₁, 0) |
| | (k₁, k₂) = | (k₁, k₂) = | (k₁, k₂) = | (k₁, k₂) = |
| | (0, 2O₂) | (0, O₂) | (0, O₂) | (4O₁, 0) |
| | (k₁, k₂) = | (k₁, k₂) = | (k₁, k₂) = | (k₁, k₂) = |
| | (4O₁, 0) | (4O₁, 0) | (O₁, O₂) | (6O₁, 0) |

TABLE 6

| | N₁ ≥ N₂ > 16 | N₁ > 16 ≥ N₂ > 1 | 16 ≥ N₁ ≥ N₂ > 1 | N₁ > 16, N₂ = 1 |
|---|---|---|---|---|
| i₁₃ = 0 | (k₁, k₂) = | (k₁, k₂) = | (k₁, k₂) = | (k₁, k₂) = |
| i₁₃ = 1 | (0, 0) | (0, 0) | (0, 0) | (0, 0) |
| i₁₃ = 2 | (k₁, k₂) = | (k₁, k₂) = | (k₁, k₂) = | (k₁, k₂) = |
| i₁₃ = 3 | (2O₁, 0) | (2O₁, 0) | (O₁, 0) | (2O₁, 0) |
| | (k₁, k₂) = | (k₁, k₂) = | (k₁, k₂) = | (k₁, k₂) = |
| | (0, 2O₂) | (0, O₂) | (0, O₂) | (4O₁, 0) |
| | (k₁, k₂) = | (k₁, k₂) = | (k₁, k₂) = | (k₁, k₂) = |
| | (4O₁, 0) | (4O₁, 0) | (O₁, O₂) | (6O₁, 0) |

TABLE 7

| | N₁ ≥ N₂ > 16 | N₁ > 16 ≥ N₂ > 1 | 16 ≥ N₁ ≥ N₂ > 1 | N₁ > 16, N₂ = 1 |
|---|---|---|---|---|
| i₁₃ = 0 | (k₁, k₂) = | (k₁, k₂) = | (k₁, k₂) = | (k₁, k₂) = |
| i₁₃ = 1 | (0, 0) | (0, 0) | (0, 0) | (0, 0) |
| i₁₃ = 2 | (k₁, k₂) = | (k₁, k₂) = | (k₁, k₂) = | (k₁, k₂) = |
| i₁₃ = 3 | (2O₁, 0) | (2O₁, 0) | (O₁, 0) | (2O₁, 0) |
| | (k₁, k₂) = | (k₁, k₂) = | (k₁, k₂) = | (k₁, k₂) = |
| | (0, 2O₂) | (0, O₂) | (0, O₂) | (4O₁, 0) |
| | (k₁, k₂) = | (k₁, k₂) = | (k₁, k₂) = | (k₁, k₂) = |
| | (4O₁, 0) | (4O₁, 0) | (2O₁, O₂) | (6O₁, 0) |

As another example, for Rank 3 and rank 4 multi panel Type I codebooks, spatial domain offsets (e.g., i_{1,3} offset) may be enhanced when more than 32 antenna ports 355 are used. In some examples, 4 spatial domain offset candidates may be used among layers, but the spatial domain offsets may be larger (e.g., scaled up) among two layers (e.g., scale up 2 times when either N₁ or N₂ is greater than 16. For example, Table 8 shows i_{1,3} offset values for different N₁ and N₂ configurations. In some examples, the quantity of candidate spatial domain offset values may be increased (e.g., i_{1,3}∈{0, 1, 2, 3, 4, 5, 6, 7}. The UE 115-a may use the i_{1,3} field in the CSI report to indicate (k₁, k₂).

TABLE 8

| | N₁ = 2, | N₁ = 4, | N₁ = 8, 16, | N₁ = 2, | N₁ = 4, 8, | N₁ = 32, | N₁ = 4, |
|---|---|---|---|---|---|---|---|
| | N₂ = 1 | N₂ = 1 | N₂ = 1 | N₂ = 2 | 16, N₂ = 2 | N₂ = 1 | N₂ = 4 |
| i₁₃ = 0 | (k₁, k₂) = | (k₁, k₂) = | (k₁, k₂) = | (k₁, k₂) = | (k₁, k₂) = | (k₁, k₂) = | (k₁, k₂) = |
| i₁₃ = 1 | (O₁, 0) | (O₁, 0) | (O₁, 0) | (O₁, 0) | (O₁, 0) | (O₁, 0) | (O₁, 0) |
| i₁₃ = 2 | | (2O₁, 0) | (2O₁, 0) | (0, O₂) | (0, O₂) | (2O₁, 0) | (0, O₂) |
| i₁₃ = 3 | | (3O₁, 0) | (3O₁, 0) | (O₁, O₂) | (O₁, O₂) | (4O₁, 0) | (2O₁, O₂) |
| | | | (4O₁, 0) | | (2O₁, 0) | (6O₁, 0) | (O₁, O₂) |

In some examples, for a Type I single panel codebook, as the beam width becomes narrower as more than 32 antenna ports 355 are used, for rank 1 and rank 2 codebooks, more options may be provided for sub-band and beam group determination. In some examples, the size of the beam group may remain four beams, and the step size or beams within the beam group may be increased (e.g., due to narrower beam width). For example, for a mode 2 codebook with N₁≥N₂>16, the beam group selection Xᵢ_{₁₁}_{,i}_{₁₂}=[v_{[ ]} . . . v_{[ ]}] may be given by [(2i₁₁, 2i₁₂), (2i₁₁+2, 2i₁₂), (2i₁₁, 2i₁₂+2), (2i₁₁+2, 2i₁₂+2)], i₁₁=0, . . . , (O₁N₁/2−1) and i₁₂=0, . . . , (O₂N_{2/2}−1), where the beam selection is from a group of four beams per group and the co-phasing selection is one or four (0, 1, 2, 3). As another example, for a mode 2 codebook with N₁>16≥N₂>1, the beam group selection Xᵢ_{₁₁}_{,i}_{₁₂}=[v_{[ ]} . . . v_{[ ]}] may be given by [2i₁₁, 2i₁₂), (2i₁₁+2, 2i₁₂), (2i₁₁, 2i₁₂+1), (2i₁₁+2, 2i₁₂+1)], i₁₁=0, . . . , (O₁N₁/2−1) and i₁₂=0, . . . , (O₂N₂/2−1) where the beam selection is from a group of four beams per group and the co-phasing selection is one or four (0, 1, 2, 3). As another example, for a mode 2 codebook with 16≥N₁≥N₂>1, the beam group selection Xᵢ_{₁₁}_{,i}_{₁₂}=[v_{[ ]} . . . v_{[ ]}] may be given by [2i₁₁, 2i₁₂], (2i₁₁+1, 2i₁₂), (2i₁₁, 2i₁₂+1), [(2i₁₁+1, 2i₁₂+1)], i₁₁=0, . . . , (O₁N₁/2−1) and i₁₂=0, . . . , (O₂N₂/2−1) where the beam selection is from a group of four beams per group and the co-phasing selection is one or four (0, 1, 2, 3). As another example, for a mode 2 codebook with N₁>16, N₂=1, the beam group selection Xᵢ_{₁₁}_{,i}_{₁₂}=[v_{[ ]} . . . v_{[ ]}] may be given by [(2i₁₁, 0), (2i₁₁+2, 0), (2i₁₁+4, 0), (2i₁₁+6, 0)], i₁₁=0, . . . , (O₁N₁/2−1) where the beam selection is from a group of four beams per group and the co-phasing selection is one or four (0, 1, 2, 3).

In some examples, the quantity of candidate beams within each beam group may be increased (e.g., due to narrower beam width). For example, for a mode 2 codebook with N₁≥N₂>16, the beam group selection Xᵢ_{₁₁}_{,i}_{₁₂}=[v_{[ ]} . . . v_{[ ]}] may be given by

$$[ \begin{matrix}( 2 {i}_{11} , 2 {i}_{12} ) , ( 2 {i}_{11} + 1 , 2 {i}_{12} ) , ( 2 {i}_{11} + 2 , 2 {i}_{12} ) , ( 2 {i}_{11} + 3 , 2 {i}_{12} ) , \\ ( 2 {i}_{11} , 2 {i}_{12} + 1 ) , ( 2 {i}_{11} + 1 , 2 {i}_{12} + 1 ) , ( 2 {i}_{11} + 2 , 2 {i}_{12} + 1 ) , \\ ( 2 {i}_{11} + 3 , 2 {i}_{12} + 1 ) \\ ( 2 {i}_{11} , 2 {i}_{12} + 2 ) , ( 2 {i}_{11} + 1 , 2 {i}_{12} + 2 ) , ( 2 {i}_{11} + 2 , 2 {i}_{12} + 2 ) , \\ ( 2 {i}_{11} + 3 , 2 {i}_{12} + 2 ) , \\ ( 2 {i}_{11} , 2 {i}_{12} + 3 ) , ( 2 {i}_{11} + 1 , 2 {i}_{12} + 3 ) , ( 2 {i}_{11} + 2 , 2 {i}_{12} + 3 ) , \\ ( 2 {i}_{11} + 3 , 2 {i}_{12} + 3 )\end{matrix} ] ,$$

$${i}_{11} = 0 , … , ( {O}_{1} {N}_{1} / 2 - 1 ) and {i}_{12} = 0 , … , ( {O}_{2} {N}_{2} / 2 - 1 ) ,$$

where the beam selection is from a group of sixteen beams per group and the co-phasing selection is one or four (0, 1, 2, 3).

In some examples, the quantity of candidate beams within each beam group may be increased (e.g., due to narrower beam width). For example, for a mode 2 codebook with N₁>16≥N₂>1, the beam group selection Xᵢ_{₁₁}_{,i}_{₁₂}=[v_{[ ]} . . . v_{[ ]}] may be given by [(2i₁₁, 2i₁₂), (2i₁₁+1, 2i₁₂), (2i₁₁+2, 2i₁₂), (2i₁₁+3, 2i₁₂), (2i₁₁, 2i₁₂+1), (2i₁₁+1, 2i₁₂+1), (2i₁₁+2, 2i₁₂+1), (2i₁₁+3, 2i₁₂+1)], i₁₁=0, . . . , (O₁N₁/2−1) and i₁₂=0, . . . , (O₂N₂/2−1), where the beam selection is from a group of eight beams per group and the co-phasing selection is one or four (0, 1, 2, 3). As another example, for a mode 2 codebook with 16≥N₁≥N₂>1, the beam group selection Xᵢ_{₁₁}_{,i}_{₁₂}=[v_{[ ]} . . . v_{[ ]}] may be given by [(2i₁₁, 2i₁₂), (2i₁₁+1, 2i₁₂), (2i₁₁, 2i₁₂+1), (2i₁₁+1, 2i₁₂+1)], i₁₁=0, . . . , (O₁N₁/2−1) and i₁₂=0, . . . , (O₂N₂/2−1), where the beam selection is from a group of four beams per group and the co-phasing selection is one or four (0, 1, 2, 3). As another example, for a mode 2 codebook with N₁>16, N₂=1, the beam group selection Xᵢ_{₁₁}_{,i}_{₁₂}=[v_{[ ]} . . . v_{[ ]}] may be given by [(2i₁₁, 0), (2i₁₁+1, 0), (2i₁₁+2, 0), (2i₁₁+3, 0), (2i₁₁+4, 0), (2i₁₁+5, 0), (2i₁₁+6, 0), (2i₁₁+7, 0)], i₁₁=0, . . . , (O₁N₁/2−1) where the beam selection is from a group of eight beams per group and the co-phasing selection is one or four (0, 1, 2, 3).

In some examples, to account for the increase in the quantity of ports and the associated narrowing of CSI-RS beams, different oversampling factors (O₁, O₂) may be applied for different ranks of a Type I single panel codebook. For example, for lower ranks, a higher oversampling factor value may be used to decrease the beam sweeping step (e.g., oversampling factor of 4). As another example, for higher ranks, a smaller oversampling factor value may be used to reduce the i₁₁ and i₁₂ overhead. In some cases, the oversampling factors (O₁, O₂) for different ranks may be predefined or standardized. In some examples, a common configuration of oversampling factors (O₁, O₂) for different ranks may be predefined or standardized, and the network entity 105-a may signal the (O₁, O₂) for different ranks via a codebook subset restriction (CBSR) method, which may be indicated via RRC.

In some examples, for a Type I single panel codebook of rank 3 to rank 8, to account for the increase in the quantity of ports and the associated narrowing of CSI-RS beams, beam selection and co-phasing selection may be employed for each sub-band.

For example, for rank 3, beam selection may be from a group of four beams per beam group and co-phasing selection may be one of two (0,1). In such examples, W may be given by

$${W}^{( {i}_{11} , {i}_{12} , {i}_{13} , {i}_{2} )} = {W}_{1}^{( {i}_{11} , {i}_{12} , {i}_{13} )} {W}_{2}^{( {i}_{2} )} , where$$

$${W}_{1}^{( {i}_{11} , {i}_{12} , {i}_{13} )} = [ \begin{matrix}{X}_{{i}_{11} , {i}_{12} , {i}_{13}} & 0 \\ 0 & {X}_{{i}_{11} , {i}_{12} , {i}_{13}}\end{matrix} ] ,$$

$${X}_{{i}_{11} , {i}_{12} , {i}_{13}} = [ \begin{matrix}( 2 {i}_{11} , 2 {i}_{12} ) , ( 2 {i}_{11} + {k}_{1} , 2 {i}_{12} + {k}_{2} ) , \\ ( 2 {i}_{11} + 1 , 2 {i}_{12} ) , ( 2 {i}_{11} + 1 + {k}_{1} , 2 {i}_{12} + {k}_{2} ) \\ ( 2 {i}_{11} , 2 {i}_{12} + 1 ) , ( 2 {i}_{11} + {k}_{1} , 2 {i}_{12} + 1 + {k}_{2} ) \\ ( 2 {i}_{11} + 1 , 2 {i}_{12} + 1 ) , ( 2 {i}_{11} + 1 + {k}_{1} , 2 {i}_{12} + 1 + {k}_{2}\end{matrix} ] ,$$

$$\begin{matrix}{i}_{11} = 0 , … , ( {O}_{1} {N}_{1} / 2 - 1 ) \\ {i}_{12} = 0 , … , ( {O}_{2} {N}_{2} / 2 - 1 )\end{matrix} ,$$

$${φ}_{{i}_{21}} ∈ \{ 0 , 1 \} , ( {y}_{1} , {y}_{2} ) ∈ \{ \begin{matrix}( {e}_{0}^{″} {e}_{1}^{″} ) , ( {e}_{2}^{″} , {e}_{3}^{″} ) , \\ ( {e}_{4}^{″} , {e}_{5}^{″} ) , ( {e}_{6}^{″} , {e}_{7}^{″} )\end{matrix} \} ,$$

$${W}_{2}^{( {i}_{2} )} = \frac{1}{\sqrt{2 P}} [ \begin{matrix}{y}_{1} & {y}_{2} & {y}_{1} \\ {φ}_{{i}_{21}} {y}_{1} & {φ}_{{i}_{21}} {y}_{2} & - {φ}_{{i}_{21}} {y}_{1}\end{matrix} ] , and {e}_{m}^{″}$$

refers to the m-th column of a 8×8 identity matrix.

As another example, for rank 8, beam selection may be from a group of four beams per beam group and co-phasing selection may be one of two (0,1). In such examples, W may be given by

$${W}^{( {i}_{11} , {i}_{12} , {i}_{13} , {i}_{2} )} = {W}_{1}^{( {i}_{11} , {i}_{12} , {i}_{13} )} {W}_{2}^{( {i}_{2} )} , where$$

$${w}_{1}^{( {i}_{11} , {i}_{12 ,} , {i}_{13} )} = [ \begin{matrix}{X}_{{i}_{11} , {i}_{12} , {i}_{13}} & 0 \\ 0 & {X}_{{i}_{11} , {i}_{12} , {i}_{13}}\end{matrix} ] ,$$

$${X}_{{i}_{11} , {i}_{12} , {i}_{13}} = [ \begin{matrix}( 2 {i}_{11} , 2 {i}_{12} ) , ( 2 {i}_{11} + {O}_{1} , 2 {i}_{12} ) , ( 2 {i}_{11} , 2 {i}_{12} + {O}_{2} ) , \\ ( 2 {i}_{11} + {O}_{1} , 2 {i}_{12} + {O}_{2} ) , \\ ( 2 {i}_{11} + 1 , 2 {i}_{12} ) , ( 2 {i}_{11} + 1 + {O}_{1} , 2 {i}_{12} ) , ( 2 {i}_{11} , + 1 , 2 {i}_{12} + {O}_{2} ) , \\ ( 2 {i}_{11} + 1 + {O}_{1} , 2 {i}_{12} + {O}_{2} ) \\ ( 2 {i}_{11} , 2 {i}_{12} + 1 ) , ( 2 {i}_{11} + {O}_{1} , 2 {i}_{12} + 1 ) , ( 2 {i}_{11} , 2 {i}_{12} + 1 + {O}_{2} ) , \\ ( 2 {i}_{11} + {O}_{1} , 2 {i}_{12} + 1 + {O}_{2} ) \\ ( 2 {i}_{11} + 1 , 2 {i}_{12} + 1 ) , ( 2 {i}_{11} + 1 + {O}_{1} , 2 {i}_{12} + 1 ) , \\ ( 2 {i}_{11} + 1 , 2 {i}_{12} + 1 + {O}_{2} ) , \\ ( 2 {i}_{11} + 1 + {O}_{1} , 2 {i}_{12} + 1 + {O}_{2} )\end{matrix} ] ,$$

$$\begin{matrix}{i}_{11} = 0 , … , ( {O}_{1} {N}_{1} / 2 - 1 ) \\ {i}_{12} = 0 , … , ( {O}_{2} {N}_{2} / 2 - 1 )\end{matrix} ,$$

$${φ}_{{i}_{21 , i}} ∈ \{ 0 , 1 \} , ( {y}_{1} , {y}_{2} , {y}_{3} , {y}_{4} ) ∈ \{ \begin{matrix}{e}_{0}^{″} {e}_{1}^{″} {e}_{2}^{″} , {e}_{0}^{″} ) \\ ( {e}_{4}^{″} , {e}_{5}^{″} {e}_{6}^{″} , {e}_{7}^{″} ) \\ ( {e}_{8}^{″} , {e}_{9}^{″} {e}_{10}^{″} , {e}_{11}^{″} ) \\ ( {e}_{12}^{″} , {e}_{13}^{″} {e}_{14}^{″} , {e}_{15}^{″} )\end{matrix} \} ,$$

$$( {y}_{1} , {y}_{2} , {y}_{3} , {y}_{4} ) ∈ \{ \begin{matrix}{e}_{0}^{″} {e}_{1}^{″} {e}_{2}^{″} , {e}_{0}^{″} ) \\ ( {e}_{4}^{″} , {e}_{5}^{″} {e}_{6}^{″} , {e}_{7}^{″} ) \\ ( {e}_{8}^{″} , {e}_{9}^{″} {e}_{10}^{″} , {e}_{11}^{″} ) \\ ( {e}_{12}^{″} , {e}_{13}^{″} {e}_{14}^{″} , {e}_{15}^{″} )\end{matrix} \} , and {e}_{m}^{″}$$

refers to the m-th column of a 16×16 identity matrix.

eType II codebooks may also be extended beyond 32 antenna ports 355. For example, for eType II codebooks, example configurations of quantities of ports, and possible configurations for (N₁, N₂) and (O₁, O₂) are shown in Table 9.

TABLE 9

| Quantity of Ports | (N₁, N₂) | (O₁, O₂) |
|---|---|---|
| 4 | (2, 1) | (4, 1) |
| 8 | (2, 2) | (4, 4) |
| | (4, 1) | (4, 1) |
| 12 | (2, 3) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |
| 64 | (8, 4) | (4, 4) |
| | (16, 2) | (4, 4) |
| | (32, 1) | (4, 1) |
| 128 | (8, 8) | (4, 4) |
| | (16, 4) | (4, 4) |
| | (32, 2) | (4, 4) |
| | (64, 1) | (4, 1) |

As described herein, the beam width becomes narrower as more than 32 antenna ports 355 are used, and a beam with higher dimensions may be better represented with more orthogonal spatial domain bases. In some examples, for a single panel eType II codebook, more parameter combinations may be supported for more than 32 antenna ports 355, particularly for spatial domain bases. For example, for more than 32 antenna ports 355, more than 6 spatial domain bases (L) may be supported (e.g., L={2, 4, 6, 8}. Frequency domain bases (M) may be given by

$${M}_{1} = {M}_{2} = ⌈ {p}_{1} \times \frac{{N}_{3}}{R} ⌉ and$$

$${M}_{3} = {M}_{4} = ⌈ {p}_{3} \times \frac{{N}_{3}}{R} ⌉ .$$

The quantity of NZCs (K₀) may be given by K₀=┌β×2LM₁┐. The network entity 105-a may indicate a configuration for a combination of combination of (L, p₁, p₃, β) in control signaling 315 (e.g., in RRC). Table 10 shows example configurations for L, p₁, p₃, β. For configurations 6 and 7, optionally RI=1−2, 32 ports, R=1.

TABLE 10

| Configuration | L | p (RI = 1-2) | p (RI = 3-4) | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ½ | ¼ | ½ |
| 6 | 4 | ¼ | ¼ | ¾ |
| 7 | 6 | ¼ | — | ½ |
| 8 | 6 | ¼ | — | ¾ |
| 9 | 8 | ¼ | ⅛ | ¼ |

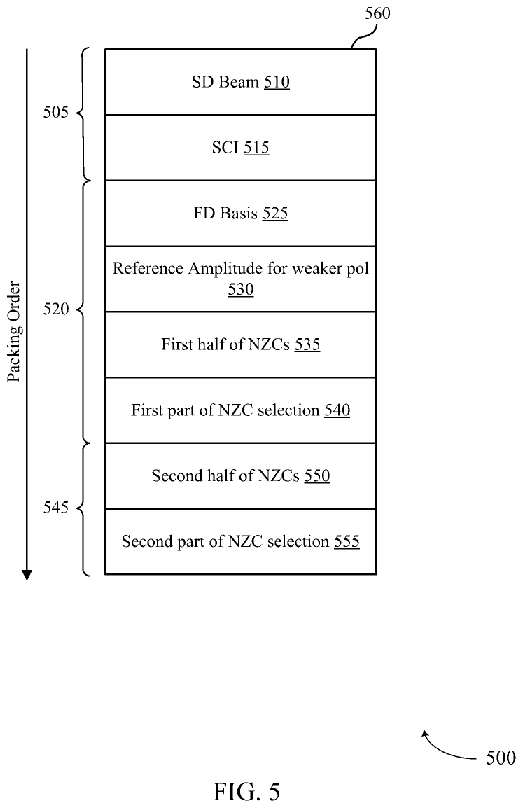

In some examples, the network entity 105-a may transmit the CSI-RSs 320 via multiple antenna panels, and the UE 115-a may generate the CSI report using an eType II multi panel codebook. For an eType II multi panel codebook, (N_{g}, N₁, N₂), N_{g}≥2, P_{CSI-RS}=2N_{g} N₁ N₂. A multi panel structure may be more efficient than a single panel structure for larger quantities of antenna ports. When the UE is configured with an eType II multi panel codebook (e.g., via the control signaling 315), at least one of the codebook structures described with reference to FIG. 5 may be used to derive and/or report PMI. The different codebook structures may be configured with different modes (e.g., mode 1, mode 2, and mode 3). Which mode to use may be indicated via RRC (e.g., the control signaling 315.) Table 11 shows example configurations of quantities of ports, and possible configurations for (N_{g}, N₁, N₂) and (O₁, O₂) for an eType II multi panel codebook.

TABLE 11

| Quantity of ports (P) | (N_{g}, N₁, N₂) | (O₁, O₂) |
|---|---|---|
| 8 | (2, 2, 1) | (4, 1) |
| 16 | (2, 4, 1) | (4, 1) |
| | (4, 2, 1) | (4, 1) |
| | (2, 2, 2) | (4, 4) |
| 32 | (2, 8, 1) | (4, 1) |
| | (4, 4, 1) | (4, 1) |
| | (2, 4, 2) | (4, 4) |
| | (4, 2, 2) | (4, 4) |
| 64 | (2, 16, 1) | (4, 1) |
| | (2, 8, 2) | (4, 4) |
| | (2, 4, 4) | (4, 4) |
| | (4, 8, 1) | (4, 1) |
| | (4, 4, 2) | (4, 4) |
| 128 | (2, 32, 1) | (4, 1) |
| | (2, 16, 2) | (4, 4) |
| | (2, 8, 4) | (4, 4) |
| | (4, 16, 1) | (4, 1) |
| | (4, 8, 2) | (4, 4) |
| | (4, 4, 4) | (4, 4) |

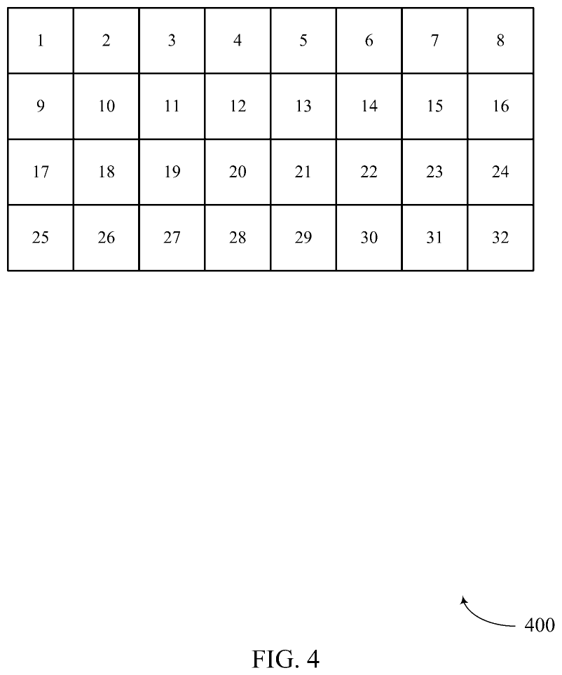

FIG. 4 shows an example of a beam configuration 400 that supports channel state information codebook enhancements in accordance with one or more aspects of the present disclosure. The beam configuration 400 may implement or be implemented by aspects of wireless communications system 100 or the wireless communications system 300. The beam configuration 400 shows 32 potential beams for beam selection.

A rank 1 single panel Type I codebook may support both mode 1 and mode 2 and may keep legacy DFT structure. For a rank 1 single panel Type I codebook, W may be given by

$${W}^{( {i}_{11} , {i}_{12} , {i}_{2} )} = {W}_{1}^{( {i}_{11} , {i}_{12} )} {W}_{2}^{( {i}_{2} )} , where {W}_{1}^{( {i}_{11} , {i}_{12} )} = [ \begin{matrix}{X}_{{i}_{11} , {i}_{12}} & 0 \\ 0 & {X}_{{i}_{11} , {i}_{12}}\end{matrix} ] ,$$

$${W}_{2}^{( {i}_{2} )} = \frac{1}{\sqrt{P}} [ \begin{matrix}{e}_{{i}_{22}} \\ {φ}_{{i}_{21}} {e}_{{i}_{22}}\end{matrix} ] , {φ}_{n} = {e}^{j π n / 2} , and {e}_{m}^{″}$$

refers to the m-th column of a 4×4 identity matrix. For a mode 1 codebook, beam group selection Xᵢ_{₁₁}_{,i}_{₁₂}=[v_{[ ]} . . . v_{[ ]}] may be given by [(i₁₁, i₁₂)], i₁₁=i₁₂=0, . . . , (ON−1). In a mode 1 codebook, the UE 115 does not select a beam from a beam group, but selects a beam group (e.g., beam 1 is beam group 1, beam 2 is beam group 2, beam 2 is beam group 3, beam 4 is beam group 4, beam 5 is beam group 5, beam 6 is beam group 6, beam 7 is beam group 7, and beam 8 is beam group 8), and the co-phasing selection is one or four (0, 1, 2, 3). For a mode 2 codebook, the UE 115 selects a beam from the beam group. For example, for a mode 2 codebook where N₂>1, beam group selection Xᵢ_{₁₁}_{,i}_{₁₂}=[v_{[ ]} . . . v_{[ ]}] may be given by [(2i₁₁, 2i₁₂), (2i₁₁+1, 2i₁₂), (2i₁₁, 2i₁₂+1), (2i₁₁+1, 2i₁₂+1)], i₁₁=i₁₂=0, . . . , (ON/2−1). For a mode 2 codebook where N₂>1, each beam group is 2×2 (e.g., a first beam group includes beams 1, 2, 9, and 10; a second beam group includes beams 3, 4, 11, and 12; a third beam group includes beams 5, 6, 13, and 14; a fourth beam group includes beams 7, 8, 15, and 16; a fifth beam group includes beams 17, 18, 25, and 26; a sixth beam group includes beams 19, 20, 27, and 28; a seventh beam group includes beams 21, 22, 29, and 20; and an eighth beam group includes beams 23, 24, 31, and 32), beam selection is from a group of four beams per group, and the co-phasing selection is one or four (0, 1, 2, 3). For a mode 2 codebook where N₂=1, beam group selection Xᵢ_{₁₁}_{,i}_{₁₂}=[v_{[ ]} . . . v_{[ ]}] may be given by [(2i₁₁, 0), (2i₁₁+1, 0), (2i₁₁+2, 0), (2i₁₁+3, 0)], i₁₁=0, . . . , (O₁N₁/2−1). For a mode 2 codebook where N₂=1, each beam group is 4×1 (e.g., a first beam group includes beams 1, 2, 3, and 4; a second beam group includes beams 11, 12, 13, and 14; and a third beam group includes beams 21, 22, 23, and 24), beam selection is from a group of four beams per group, and the co-phasing selection is one or four (0, 1, 2, 3).

As described herein, a rank 2 single panel Type I codebook may support both mode 1 and mode 2 and may keep legacy DFT structure. For a rank 2 single panel Type I codebook, W may be given by

$${W}^{( {i}_{11} , {i}_{12} , {i}_{13} , {i}_{2} )} = {W}_{1}^{( {i}_{11} , {i}_{12} , {i}_{13} )} {W}_{2}^{( {i}_{2} )} , where {W}_{1}^{( {i}_{11} , {i}_{12} , {i}_{13} )} = [ \begin{matrix}{X}_{{i}_{11} , {i}_{12} , {i}_{13}} & 0 \\ 0 & {X}_{{i}_{11} , {i}_{12} , {i}_{13}}\end{matrix} ] , {W}_{2}^{( {i}_{2} )} = \frac{1}{\sqrt{2 P}} [ \begin{matrix}{y}_{1} & {y}_{2} \\ {φ}_{{i}_{21}} {y}_{1} & - {φ}_{{i}_{21}} {y}_{2}\end{matrix} ] ,$$

φn=e^{jπn/2},

$${e}_{m}^{′}$$

refers to the m-th column of a 2×2 identity matrix, and

$${e}_{m}^{″}$$

refers to the m-th column of a 8×8 identity matrix. For a mode 1 codebook, beam group selection Xᵢ_{₁₁}_{,i}_{₁₂}_{,i}_{₁₃}=[v_{[ ]} . . . v_{[ ]}] may be given by [i₁₁, i₁₂), (i₁₁+k₁, i₁₂+k₂)],

$$\begin{matrix}{i}_{11} = 0 , … , ( {O}_{1} {N}_{1} - 1 ) \\ {i}_{12} = 0 , … , ( {O}_{2} {N}_{2} - 1 )\end{matrix} ,$$

co-phasing selection may be given by φᵢ_{₂₁}∈{0, 1}, and beam selection may be given by

$$( {y}_{1} , {y}_{2} ) = ( {e}_{0}^{′} , {e}_{1}^{′} )$$

(e.g., one or beams 1 or 5). For a mode 2 codebook where N₂>1, beam group selection Xᵢ_{₁₁}_{,i}_{₁₂}_{,i}_{₁₃}=[v_{[ ]} . . . v_{[ ]}] may be given by

$$[ \begin{matrix}\begin{matrix}( 2 {i}_{11} , 2 {i}_{12} ) , ( 2 {i}_{11} + {k}_{1} , 2 {i}_{12} + {k}_{2} ) , \\ ( 2 {i}_{11} + 1 , 2 {i}_{12} ) , ( 2 {i}_{11} + 1 + {k}_{1} , 2 {i}_{12} + {k}_{2} )\end{matrix} \\ \begin{matrix}( 2 {i}_{11} , 2 {i}_{12} + 1 ) , ( 2 {i}_{11} + {k}_{1} , 2 {i}_{12} + 1 + {k}_{2} ) \\ ( 2 {i}_{11} + 1 , 2 {i}_{12} + 1 ) , ( 2 {i}_{11} + 1 + {k}_{1} , 2 {i}_{12} + 1 + {k}_{2} )\end{matrix}\end{matrix} ] , \begin{matrix}{i}_{11} = 0 , … , ( {O}_{1} {N}_{1} / 2 - 1 ) \\ {i}_{12} = 0 , … , ( {O}_{2} {N}_{2} / 2 - 1 )\end{matrix} ,$$

co-phasing selection may be given by φᵢ_{₂₁}∈{0, 1}, and beam selection may be given by

$$( {y}_{1 ,} {y}_{2} ) ∈ \{ \begin{matrix}( {e}_{0}^{″} {e}_{1}^{″} ) , ( {e}_{2}^{″} , {e}_{3}^{″} ) , \\ ( {e}_{4}^{″} , {e}_{5}^{″} ) , ( {e}_{6}^{″} , {e}_{7}^{″} )\end{matrix} \}$$

(e.g., one of beams 1, 2, 9, or 10 of a first beam group or beams 5, 6, 13, or 14 of a second beam group). For a mode 2 codebook where N₂=1, beam group selection Xᵢ_{₁₁}_{,i}_{₁₂}_{,i}_{₁₃}=[v_{[ ]} . . . v_{[ ]}] may be given by

$$[ \begin{matrix}\begin{matrix}( 2 {i}_{11} , 0 ) , ( 2 {i}_{11} + {k}_{1} , 0 ) , \\ ( 2 {i}_{11} + 1 , 0 ) , ( 2 {i}_{11} + 1 + {k}_{1} , 0 )\end{matrix} \\ \begin{matrix}( 2 {i}_{11} + 2 , 0 ) , ( 2 {i}_{11} + 2 + {k}_{1} , 0 ) \\ ( 2 {i}_{11} + 3 , 0 ) , ( 2 {i}_{11} + 3 + {k}_{1} , 0 )\end{matrix}\end{matrix} ] , \begin{matrix}{i}_{11} = 0 , … , ( {O}_{1} {N}_{1} / 2 - 1 ) \\ {i}_{11} = 0 , … , ( {O}_{2} {N}_{2} / 2 - 1 )\end{matrix} ,$$

co-phasing selection may be given by φᵢ_{₂₁}∈{0, 1}, and beam selection may be given by

$$( {y}_{1 ,} {y}_{2} ) ∈ \{ \begin{matrix}( {e}_{0}^{″} {e}_{1}^{″} ) , ( {e}_{2}^{″} , {e}_{3}^{″} ) , \\ ( {e}_{4}^{″} , {e}_{5}^{″} ) , ( {e}_{6}^{″} , {e}_{7}^{″} )\end{matrix} \}$$

(e.g., one of beams 1, 2, 3, or 4 of a first beam group or beams 5, 6, 7, or 8 of a second beam group).

As described herein, a rank 3 or rank 4 single panel Type I codebook may support single codebook mode and may keep legacy DFT structure. For a rank 3 single panel Type I codebook, W may be given by

$${W}^{( {i}_{11} , {i}_{12} , {i}_{13} , {i}_{2} )} = {W}_{1}^{( {i}_{11} , {i}_{12} , {i}_{13} )} {W}_{2}^{( {i}_{2} )} , where {W}_{1}^{( {i}_{11} , {i}_{12} , {i}_{13} )} = [ \begin{matrix}{X}_{{i}_{11} , {i}_{12} , {i}_{13}} & 0 \\ 0 & {X}_{{i}_{11} , {i}_{12} , {i}_{13}}\end{matrix} ] , {W}_{2}^{( {i}_{2} )} = \frac{1}{\sqrt{3 P}} [ \begin{matrix}Y & y \\ {φ}_{{i}_{2}} Y & - {φ}_{{i}_{2}} y\end{matrix} ] ,$$

φₙ=e^{jπn/2}, and

$${e}_{m}^{′}$$

refers to the m-th column of a 2×2 identity matrix. For a mode 1 or mode 2 rank 3 codebook, beam group selection may be given by [(i₁₁, i₁₂), (i₁₁+k₁, i₁₂+k₂)],

$$\begin{matrix}{i}_{11} = 0 , … , ( {O}_{1} {N}_{1} - 1 ) \\ {i}_{12} = 0 , … , ( {O}_{2} {N}_{2} - 1 )\end{matrix} ,$$

co-phasing selection may be given by φᵢ_{₂}∈{0, 1}, and beam selection may be given by

$$Y = [ {e}_{0}^{′} {e}_{1}^{′} ] , y = {e}_{0}^{′}$$

(e.g., one of beams 1 or 5). For a rank 4 single panel Type I codebook, W may be given by

$${W}^{( {i}_{11} , {i}_{12} , {i}_{13} , {i}_{2} )} = {W}_{1}^{( {i}_{11} , {i}_{12} , {i}_{13} )} {W}_{2}^{( {i}_{2} )} , where {W}_{1}^{( {i}_{11} , {i}_{12} , {i}_{13} )} = [ \begin{matrix}{X}_{{i}_{11} , {i}_{12} , {i}_{13}} & 0 \\ 0 & {X}_{{i}_{11} , {i}_{12} , {i}_{13}}\end{matrix} ] , {W}_{2}^{( {i}_{2} )} = \frac{1}{\sqrt{4 P}} [ \begin{matrix}Y & Y \\ {φ}_{{i}_{2}} Y & - {φ}_{{i}_{2}} Y\end{matrix} ] , {φ}_{n} = {e}^{j π n / 2} , and {e}_{m}^{′}$$

refers to the m-th column of a 2×2 identity matrix. For a mode 1 or mode 2 rank 4 codebook, beam group selection may be given by [(i₁₁, i₁₂), (i₁₁+k₁, i₁₂+k₂)],

$$\begin{matrix}{i}_{11} = 0 , … , ( {O}_{1} {N}_{1} - 1 ) \\ {i}_{12} = 0 , … , ( {O}_{2} {N}_{2} - 1 )\end{matrix} ,$$

co-phasing selection may be given by φᵢ_{₂}∈{0, 1}, and beam selection may be given by

$$Y = [ {e}_{0}^{′} \qquad {e}_{1}^{′} ]$$

(e.g., one of beams 1 or 5).

Rank 5 to rank 8 single panel Type I codebook with more than 32 antenna ports may support single codebook mode and may keep legacy DFT structure. Rank 5 to rank 8 single panel Type I codebooks with more than 32 antenna ports may scale up (e.g., by 2) the fixed spatial domain offset between layers (e.g., as a larger quantity of antenna ports results in a narrower beam width, and a larger spatial domain offset may be used to better recognize uncorrelated propagation path).

For example, for a rank 5 single panel Type I codebook, W may be given by

$${W}^{( {i}_{11} , {i}_{12} , {i}_{2} )} = {W}_{1}^{( {i}_{11} , {i}_{12} )} {W}_{2}^{( {i}_{2} )} , where {W}_{1}^{( {i}_{11} , {i}_{12} )} = [ \begin{matrix}{X}_{{i}_{11} , {i}_{12}} & 0 \\ 0 & {X}_{{i}_{11} , {i}_{12}}\end{matrix} ] , and$$

$${W}_{2}^{( {i}_{2} )} = \frac{1}{\sqrt{5 P}} [ \begin{matrix}{e}_{1} & {e}_{1} & {e}_{2} & {e}_{2} & {e}_{3} \\ {φ}_{{i}_{2}} {e}_{1} & - {φ}_{{i}_{2}} {e}_{1} & {e}_{2} & - {e}_{2} & {e}_{3}\end{matrix} ] ,$$

and eₘ refers to the m-th column of a 3×3 identity matrix. For a rank 5 single panel Type I codebook, the co-phasing selection may be given by φᵢ_{₂}∈{0, 1}. For a mode 1 or a mode 2 codebook, where N₁≥N₂>16, the beam group selection may be given by [(i₁₁, i₁₂), (i₁₁+2O₁, i₁₂), (i₁₁+2O₁, i₁₂+2O₂)], i₁₁=0, . . . , (O₁N₁−1), i₁₂=0, . . . , (O₂N₂−1). For a mode 1 or a mode 2 codebook, where N₁>16≥N₂>1, the beam group selection may be given by [(i₁₁, i₁₂), (i₁₁+2O₁, i₁₂), (i₁₁+2O₁, i₁₂+O₂)], i₁₁=0, . . . , (O₁N₁−1), i₁₂=0, . . . , (O₂N₂−1). For a mode 1 or a mode 2 codebook, where 16≥N₁≥N₂>1, the beam group selection may be given by [(i₁₁, i₁₂), (i₁₁+O₁, i₁₂), (i₁₁+O₁, i₁₂+O₂)], i₁₁=0, . . . , (O₁N₁−1), i₁₂=0, . . . , (O₂N₂−1). For a mode 1 or a mode 2 codebook, where N₂=1, the beam group selection may be given by [(i₁₁, 0), (i₁₁+2O₁, 0), (i₁₁+4O₁, 0)], i₁₁=0, . . . , (O₁N₁−1), i₁₂=0.

For a rank 6 single panel Type I codebook, W may be given by

$${W}^{( {i}_{11} , {i}_{12} , {i}_{2} )} = {W}_{1}^{( {i}_{11} , {i}_{12} )} {W}_{2}^{( {i}_{2} )} , where {W}_{1}^{( {i}_{11} , {i}_{12} )} = [ \begin{matrix}{X}_{{i}_{11} , {i}_{12}} & 0 \\ 0 & {X}_{{i}_{11} , {i}_{12}}\end{matrix} ] ,$$

$${W}_{2}^{( {i}_{2} )} = \frac{1}{\sqrt{6 P}} [ \begin{matrix}{e}_{1} & {e}_{1} & {e}_{2} & {e}_{2} & {e}_{3} & {e}_{3} \\ {φ}_{{i}_{2}} {e}_{1} & - {φ}_{{i}_{2}} {e}_{1} & {φ}_{{i}_{2}} {e}_{2} & - {φ}_{{i}_{2}} {e}_{2} & {e}_{3} & - {e}_{3}\end{matrix} ] ,$$

and eₘ refers to the m-th column of a 3×3 identity matrix. For a rank 6 single panel Type I codebook, the co-phasing selection may be given by φᵢ_{₂}∈{0, 1}. For a mode 1 or a mode 2 codebook, where N₁≥N₂>16, the beam group selection may be given by [(i₁₁, i₁₂), (i₁₁+2O₁, i₁₂), (i₁₁+2O₁, i₁₂+2O₂)], i₁₁=0, . . . , (O₁N₁−1), i₁₂=0, . . . , (O₂N₂−1). For a mode 1 or a mode 2 codebook, where N₁>16≥N₂>1, the beam group selection may be given by [(i₁₁, i₁₂), (i₁₁+2O₁, i₁₂), (i₁₁+2O₁, i₁₂+O₂)], i₁₁=0, . . . , (O₁N₁−1), i₁₂=0, . . . , (O₂N₂−1). For a mode 1 or a mode 2 codebook, where 16≥N₁≥N₂>1, the beam group selection may be given by [(i₁₁, i₁₂), (i₁₁+O₁, i₁₂), (i₁₁+O₁, i₁₂+O₂)], i_11=0, . . . , (O_1 N_1−1), i_12=0, . . . , (O_2 N_2−1). For a model or a mode 2 codebook, where N₂=1, the beam group selection may be given by [(i₁₁, 0), (i₁₁+2O₁, 0), (i₁₁+4O₁, 0)], i₁₁=0, . . . , (O₁N₁−1), i₁₂=0.

For a rank 7 single panel Type I codebook, W may be given by

$${W}^{( {i}_{11} , {i}_{12} , {i}_{2} )} = {W}_{1}^{( {i}_{11} , {i}_{12} )} {W}_{2}^{( {i}_{2} )} , where {W}_{1}^{( {i}_{11} , {i}_{12} )} = [ \begin{matrix}{X}_{{i}_{11} , {i}_{12}} & 0 \\ 0 & {X}_{{i}_{11} , {i}_{12}}\end{matrix} ] ,$$

$${W}_{2}^{( {i}_{2} )} = \frac{1}{\sqrt{7 P}} [ \begin{matrix}{e}_{1} & {e}_{1} & {e}_{2} & {e}_{3} & {e}_{3} & {e}_{4} & {e}_{4} \\ {φ}_{{i}_{2}} {e}_{1} & - {φ}_{{i}_{2}} {e}_{1} & {φ}_{{i}_{2}} {e}_{2} & {e}_{3} & - {e}_{3} & {e}_{4} & - {e}_{4}\end{matrix} ] ,$$

and eₘ refers to the m-th column of a 4×4 identity matrix. For a rank 7 single panel Type I codebook, the co-phasing selection may be given by φᵢ_{₂}∈{0, 1}. For a mode 1 or a mode 2 codebook, where N₁>16, N₂=1, beam group selection may be given by [(i₁₁, 0), (i₁₁+2O₁, 0), (i₁₁+4O₁, 0), (i₁₁+6O₁, 0)], i₁₁=0, . . . , (O₁N₁−1), i₁₂=0. For a mode 1 or a mode 2 codebook, where 16≥N₁≥N₂>1, beam group selection may be given by [(i₁₁, i₁₂), (i₁₁+O₁, i₁₂), (i₁₁, i₁₂+O₂), (i₁₁+O₁, i₁₂+O₂)], i₁₁=0, . . . , (O₁N₁−1), i₁₂=0, . . . , (O₂N₂−1). For a mode 1 or a mode 2 codebook, where N₁>16≥N₂>1, beam group selection may be given by [(i₁₁, i₁₂), (i₁₁+2O₁, i₁₂), (i₁₁, i₁₂+O₂), (i₁₁+2O₁, i₁₂+O₂)], i₁₁=0, . . . , (O₁N₁−1), i₁₂=0, . . . , (O₂N₂−1). For a mode 1 or a mode 2 codebook, where N₁≥N₂>16, beam group selection may be given by [(i₁₁, i₁₂), (i₁₁+2O₁, i₁₂), (i₁₁, i₁₂+2O₂), (i₁₁+2O₁, i₁₂+2O₂)], i₁₁=0, . . . , (O₁N₁−1), i₁₂=0, . . . , (O₂N₂−1).

For a rank 8 single panel Type I codebook, W may be given by

$${W}^{( {i}_{11} , {i}_{12} , {i}_{2} )} = {W}_{1}^{( {i}_{11} , {i}_{12} )} {W}_{2}^{( {i}_{2} )} , where {W}_{1}^{( {i}_{11} , {i}_{12} )} = [ \begin{matrix}{X}_{{i}_{11} , {i}_{12}} & 0 \\ 0 & {X}_{{i}_{11} , {i}_{12}}\end{matrix} ] ,$$

$${W}_{2}^{( {i}_{2} )} = \frac{1}{\sqrt{8 P}} [ \begin{matrix}{e}_{1} & {e}_{1} & {e}_{2} & {e}_{2} & {e}_{3} & {e}_{3} & {e}_{4} & {e}_{4} \\ {φ}_{{i}_{2}} {e}_{1} & - {φ}_{{i}_{2}} {e}_{1} & {φ}_{{i}_{2}} {e}_{2} & - {φ}_{{i}_{2}} {e}_{2} & {e}_{3} & - {e}_{3} & {e}_{4} & - {e}_{4}\end{matrix} ] ,$$

and eₘ refers to the m-th column of a 4×4 identity matrix. For a rank 8 single panel Type I codebook, the co-phasing selection may be given by φᵢ_{₂}∈{0, 1}. For a mode 1 or a mode 2 codebook, where N₁>16, N₂=1, beam group selection may be given by [(i₁₁, 0), (i₁₁+2O₁, 0), (i₁₁+4O₁, 0), (i₁₁+6O₁, 0)], i₁₁=0, . . . , (O₁N₁−1), i₁₂=0. For a mode 1 or a mode 2 codebook, where 16≥N₁≥N₂>1, beam group selection may be given by [(i₁₁, i₁₂), (i₁₁+O₁, i₁₂), (i₁₁, i₁₂+O₂), (i₁₁+O₁, i₁₂+O₂)], i₁₁=0, . . . , (O₁N₁−1), i₁₂=0, . . . , (O₂N₂−1). For a mode 1 or a mode 2 codebook, where N₁>16≥N₂>1, beam group selection may be given by [(i₁₁, i₁₂), (i₁₁+2O₁, i₁₂), (i₁₁, i₁₂+O₂), (i₁₁+2O₁, i₁₂+O₂)], i₁₁=0, . . . , (O₁N₁−1), i₁₂=0, . . . , (O₂N₂−1). For a mode 1 or a mode 2 codebook, where N₁≥N₂>16, beam group selection may be given by [(i₁₁, i₁₂), (i₁₁+2O₁, i₁₂), (i₁₁, i₁₂+2O₂), (i₁₁+2O₁, i₁₂+2O₂)], i₁₁=0, . . . , (O₁N₁−1), i₁₂=0, . . . , (O₂N₂−1).

FIG. 5 shows an example of a UCI packing scheme 500 that supports channel state information codebook enhancements in accordance with one or more aspects of the present disclosure. The UCI packing scheme 500 may implement or be implemented by aspects of wireless communications system 100 or the wireless communications system 300.

The UCI packing scheme 500 shows the packing order for a UCI part two 560, which may be used to transmit a CSI report (e.g., the CSI report 325 of FIG. 3) generated using an eType II codebook via UCI part two 560. Group zero 505 of the UCI part two 560 may include the spatial domain beam indication 510 (e.g., i_{1,1}, i_{1,2}) and strongest coefficient indicator (SCI) 515. Group one 520 of the UCI part two 560 may include frequency domain basis 525 (e.g., i_{1,5}, i_{1,6,l}), the reference amplitude for the weaker pol 530 (e.g., i_{2,3,l}), the first half of NZCs 535 (e.g., i_{2,4,l}, i_{2,5,l}), and the first part of NZC selection 540 (e.g., i_{1,7,l}). Group two 545 of the UCI part two 560 may include the second half of NZCs 550 (e.g., i_{2,4,l}, i_{2,5,l}), and the second of part of NZC selection 555 (e.g., i_{1,7,l}). The first half of NZCs 535 may include the

$$⌈ \frac{{K}_{NZ}^{tot}}{2} ⌉$$

highest priority NZCs. The second half of NZCs 550 may include the remaining

$$⌊ \frac{{K}_{NZ}^{tot}}{2} ⌋$$

lowest priority NZCs. The first part of NZC selection 540 may include the

$$2 L \cdot M \cdot RI - ⌊ \frac{{K}_{NZ}^{tot}}{2} ⌋$$

highest priority bits. The second part of part of NZC selection 555 may include the remaining

$$⌊ \frac{{K}_{NZ}^{tot}}{2} ⌋$$

lowest priority bits. The NZCs may be partitioned into groups to maintain a non-zero PMI if group-2 is omitted.

As described herein, a network entity 105 may transmit the CSI-RSs via multiple antenna panels, and the UE 115 may generate the CSI report using an eType II multi panel codebook. When the UE 115 is configured with an eType II multi panel codebook (e.g., via the control signaling 315 of FIG. 3), at least one of the codebook structures described with reference to FIG. 5 may be used to derive and/or report PMI.

In a first codebook structure, the same spatial basis may be used for multi-TRP, and W may be given by

$$[ \begin{matrix}{W}_{1} {\tilde{W}}_{2 , 1} {W}_{f}^{H} \\ ⋮ \\ {W}_{1} {\tilde{W}}_{2 , N} {W}_{f}^{H}\end{matrix} ] .$$

The phases and amplitudes of separate coefficients \tilde{W}_{2,1}, . . . , \tilde{W}_{2,N} for different panels may be different, and W_{f} may provide information on the common frequency basis for the different panels. Precoding information on W₁ which is common for all panels may be reported in UCI (e.g., the UCI part two 560). For example, the same basis may be reported for different TRPs. The spatial domain basis of W₁ may be determined based on the per-panel parameter (N₁, N₂) and packed in Group zero 505 in UCI part two 560. [\tilde{W}_{2,1}, . . . , \tilde{W}_{2,N}] may be jointly packed in Group one 520 and Group two 545 based on the priority values. The quantity of NZC may be determined based on either K₀=┌β×2N_{g}LM₁┐ or K₀=┌β×2LM₁┐, which may be reported in UCI part 1. The SCI and priority calculation may be based on the whole [\tilde{W}_{2,1}, . . . , \tilde{W}_{2,N}] matrix.

In a second codebook structure, the same spatial and frequency basis may be used for multi-TRP with co-phasing, and W may be given by

$$[ \begin{matrix}{W}_{1} {\tilde{W}}_{2} {W}_{f}^{H} \\ {W}_{1} {ϕ}_{2} {\tilde{W}}_{2} {W}_{f}^{H} \\ ⋮ \\ {W}_{1} {ϕ}_{N} {\tilde{W}}_{2} {W}_{f}^{H}\end{matrix} ] = [ \begin{matrix}{W}_{1} {\tilde{W}}_{2} {W}_{f}^{H} \\ {ϕ}_{2} {W}_{1} {\tilde{W}}_{2} {W}_{f}^{H} \\ ⋮ \\ {ϕ}_{N} {W}_{1} {\tilde{W}}_{2} {W}_{f}^{H}\end{matrix} ] .$$

Co-phasing values for different panels may be introduced to allow for flexible inter-panel distance and phase-offset between panels. Precoding information on W₁ which is common for all panels may be reported in UCI (e.g., the UCI part two 560). For example, the same basis may be reported for different TRPs. The spatial domain basis of W₁ may be determined based on the per-panel parameter (N₁, N₂) and packed in Group zero 505 in UCI part two 560. Co-phasing values [φ₂, . . . , φ_{N}] between different panels may be reported within a given alphabet (e.g., Quadrature Phase Shift Keying (QPSK), 8 Phase-Shift Keying (8PSK) or 16 Phase-Shift Keying (16PSK). φ₂, . . . , φ_{N} may be either layer-common or layer-specific. φ₂, . . . , φ_{N} may be packed either in Group zero 505 or in Group one 520 in UCI part two 560. \tilde{W}₂ may be common for different panels and may be packed in Group one 520 and Group two 545 based on priority value. The quantity of NZC may be determined based on either K₀=┌β×2LM₁┐, which may be reported in UCI part 1.

In a third codebook structure, the same spatial and frequency basis and coefficients may be used for multi-TRP. Different co-phasing values may be used for different polarizations. W may be given by

$$[ \begin{matrix}{W}_{1} {\tilde{W}}_{2} {W}_{f}^{H} \\ {W}_{1} [ \begin{matrix}{ϕ}_{2}^{pol 1} {I}_{L} & {0}_{L} \\ {0}_{L} & {ϕ}_{2}^{pol 2} {I}_{L}\end{matrix} ] {\tilde{W}}_{2} {W}_{f}^{H} \\ ⋮ \\ {W}_{1} [ \begin{matrix}{ϕ}_{N}^{pol 1} {I}_{L} & {0}_{L} \\ {0}_{L} & {ϕ}_{N}^{pol 2} {I}_{L}\end{matrix} ] {\tilde{W}}_{2} {W}_{f}^{H}\end{matrix} ] ,$$

where I_{L} is an L×L identity matrix and O_{L} is an L×L zero matrix. The third codebook structure may be similar to the second codebook structure, with the use of different co-phasing values for different polarizations. Precoding information on W₁ which is common for all panels may be reported in UCI (e.g., the UCI part two 560). For example, the same basis may be reported for different TRPs. The spatial domain basis of W₁ may be determined based on the per-panel parameter (N₁, N₂) and packed in Group zero 505 in UCI part two 560. The Co-phasing values

$${ϕ}_{2}^{pol 1} , … , {ϕ}_{N}^{pol 1} and {ϕ}_{2}^{pol 2} , … , {ϕ}_{N}^{pol 2}$$

between different panels may be reported within a given alphabet (e.g., QPSK, 8PSK, or 16PSK).

$${ϕ}_{2}^{pol 1} , … , {ϕ}_{N}^{pol 1} and {ϕ}_{2}^{pol 2} , … , {ϕ}_{N}^{pol 2}$$

may be either layer-common or layer-specific.

$${ϕ}_{2}^{pol 1} , … , {ϕ}_{N}^{pol 1} and {ϕ}_{2}^{pol 2} , … , {ϕ}_{N}^{pol 2}$$

may be packed either in Group zero 505 or Group one 520 in UCI part two 560. \tilde{W}₂ may be common for different panels and may be packed in Group one 520 and Group two 545 based on priority value. The quantity of NZC may be determined based on either K₀=┌β×2LM₁┐, which may be reported in UCI part 1.

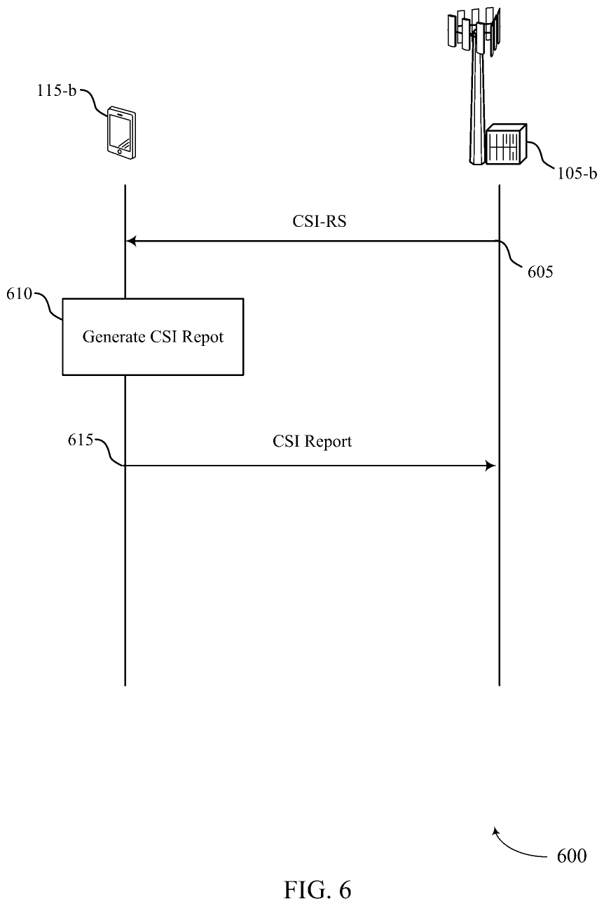

FIG. 6 shows an example of a process flow 600 that supports channel state information codebook enhancements in accordance with one or more aspects of the present disclosure. The process flow 600 may implement or be implemented by aspects of wireless communications system 100 or the wireless communications system 300. For example, the process flow 600 may include a UE 115-b, which may be an example of a UE 115 as described herein. The process flow 600 may also include a network entity 105-b, which may be an example of a network entity 105 as described herein. In the following description of the process flow 600, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 600, and other operations may be added to the process flow 600.

At 605, the network entity 105-b may transmit, to the UE 115-b, a set of CSI-RSs from a set of antenna ports at the network entity 105-b.

At 610, the UE 115-b may generate a channel state information report in accordance with a codebook. A size of a downlink channel matrix estimated based on the set of CSI-RSs and used to generate the channel state information report is based on a quantity of antenna ports that is included in the set of antenna ports, and at least one parameter of the codebook is based on the quantity of antenna ports exceeding a threshold. In some examples, the threshold is 32 antenna ports. In some examples, prior to transmission of the CSI-RSs at 605, the network entity 105-b may indicate the codebook to the UE 115-b, including the quantity of antenna ports.

At 615, the UE 115-b may transmit, to the network entity 105-b, the CSI report.

In some examples, the codebook is a type one (also referred to as Type I) single-panel codebook. In some examples, the at least one parameter is a first spatial domain offset between layers of a precoding matrix, the channel state information report is based on the precoding matrix, a rank indication of the precoding matrix is between two layers and eight layers, and the first spatial domain offset is larger than a second spatial domain offset associated with the quantity of antenna ports being at or below the threshold. In some examples, the at least one parameter is a spatial domain offset between layers of a precoding matrix, the channel state information report is based on the precoding matrix, a rank indication of the precoding matrix is between two layers and eight layers, and a size of the spatial domain offset is based on a configuration of horizontal antenna elements and vertical antenna elements used to transmit the set of CSI-RSs. In some examples, the at least one parameter is a first quantity of candidate spatial domain offsets between layers of a precoding matrix, the channel state information report is based on the precoding matrix, a rank indication of the precoding matrix is between two layers and four layers, and the first quantity of candidate spatial domain offsets is larger than a second quantity of candidate spatial domain offsets associated with the quantity of antenna ports being at or below the threshold. In some examples, the at least one parameter is a first step size between beams of each beam group of a set of multiple beam groups associated with the Type I single-panel codebook, and the first step size is larger than a second step size associated with the quantity of antenna ports being at or below the threshold. In some examples, the at least one parameter is a first quantity of beams within each of a set of multiple beam groups associated with the Type I single-panel codebook, and the first quantity of beams is larger than a second quantity of beams width associated with the Type I single-panel codebook associated with the quantity of antenna ports being at or below the threshold. In some examples, the at least one parameter is an oversampling factor, and a size of the oversampling factor is based on a rank of the channel state information report. In some examples, the at least one parameter is a respective beam selection and a respective co-phasing selection for each sub-band of a set of multiple sub-bands of the set of CSI-RSs, a rank indication of a precoding matrix is between three layers and eight layers, and the channel state information report is based on the precoding matrix.

In some examples, the codebook is a Type I multi-panel codebook. In some examples, the at least one parameter is a first spatial domain offset between layers of a precoding matrix, the channel state information report is based on the precoding matrix, a rank indication of the precoding matrix is three or four layers, and the first spatial domain offset is larger than a second spatial domain offset associated with the quantity of antenna ports being at or below the threshold. In some examples, the at least one parameter is a first quantity of candidate spatial domain offsets between layers of a precoding matrix, the at least one parameter is a first quantity of candidate spatial domain offsets between layers of a precoding matrix, the channel state information report is based on the precoding matrix, a rank indication of the precoding matrix is between two layers and four layers, and the first quantity of candidate spatial domain offsets is larger than a second quantity of candidate spatial domain offsets associated with the quantity of antenna ports being at or below the threshold.

In some examples, the codebook is an Enhanced type two (also referred to as eType II) single-panel codebook. In some examples, the at least one parameter is a first quantity of spatial domain bases, and the first quantity of spatial domain bases is larger than a second quantity of spatial domain bases associated with the quantity of antenna ports being at or below the threshold.

In some examples, the codebook is an Enhanced type II multi-panel codebook. In some examples, the at least one parameter is the use of a same set of spatial domain bases for each panel of a set of multiple panels used to transmit the set of CSI-RSs. In some examples, the CSI report is received via a UCI, an indication of the set of spatial domain bases are packed in group zero of part two of the UCI, a set of non-zero coefficients for each layer are indicated in a group one or a group two of part two of the UCI, and a quantity of non-zero coefficients of the set of non-zero coefficients for each layer is indicated in part one of the UCI. In some examples, the at least one parameter is the use of a same set of spatial domain bases, a same set of frequency domain bases, and a different co-phasing value for each panel of a set of multiple panels used to transmit the set of CSI-RSs. In some examples, the at least one parameter is the use of a same set of non-zero coefficients for each panel of the set of multiple panels. In some examples, the CSI report is received via a UCI, an indication of the set of spatial domain bases are packed in group zero of part two of the UCI, the different co-phasing value for each panel is reported in the group zero or a group one of part two of the UCI, a set of non-zero coefficients are indicated in the group one or a group two of part two of the UCI, and a quantity of non-zero coefficients of the set of non-zero coefficients is indicated in part one of the UCI.

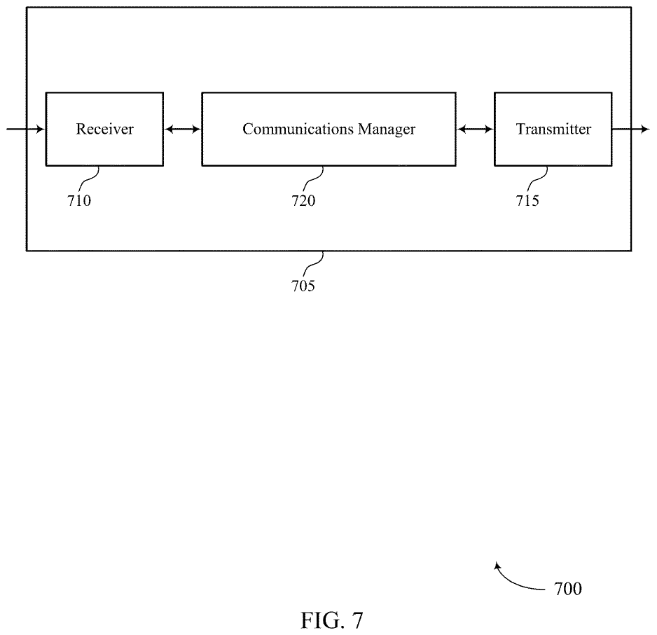

FIG. 7 shows a block diagram 700 of a device 705 that supports channel state information codebook enhancements in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to channel state information codebook enhancements). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel state information codebook enhancements). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of channel state information codebook enhancements as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 is capable of, configured to, or operable to support a means for receiving, from a network entity, a set of CSI-RSs from a set of antenna ports at the network entity. The communications manager 720 is capable of, configured to, or operable to support a means for generating a channel state information report in accordance with a codebook, where a size of a downlink channel matrix estimated based on the set of CSI-RSs and used to generate the channel state information report is based on a quantity of antenna ports that is included in the set of antenna ports, and where at least one parameter of the codebook is based on the quantity of antenna ports exceeding a threshold. The communications manager 720 is capable of, configured to, or operable to support a means for transmitting, to the network entity, the channel state information report.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

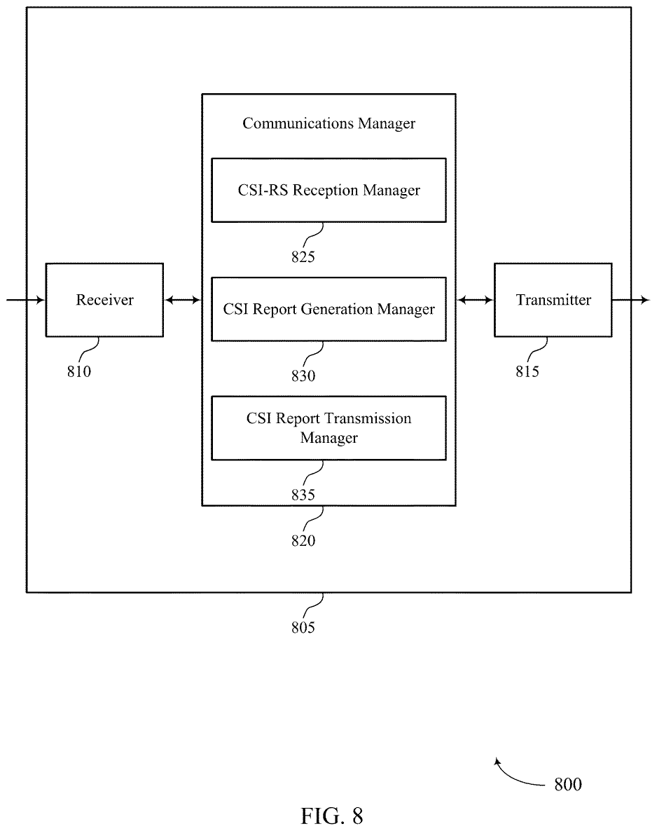

FIG. 8 shows a block diagram 800 of a device 805 that supports channel state information codebook enhancements in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to channel state information codebook enhancements). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to channel state information codebook enhancements). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of channel state information codebook enhancements as described herein. For example, the communications manager 820 may include a CSI-RS reception manager 825, a CSI report generation manager 830, a CSI report transmission manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The CSI-RS reception manager 825 is capable of, configured to, or operable to support a means for receiving, from a network entity, a set of CSI-RSs from a set of antenna ports at the network entity. The CSI report generation manager 830 is capable of, configured to, or operable to support a means for generating a channel state information report in accordance with a codebook, where a size of a downlink channel matrix estimated based on the set of CSI-RSs and used to generate the channel state information report is based on a quantity of antenna ports that is included in the set of antenna ports, and where at least one parameter of the codebook is based on the quantity of antenna ports exceeding a threshold. The CSI report transmission manager 835 is capable of, configured to, or operable to support a means for transmitting, to the network entity, the channel state information report.

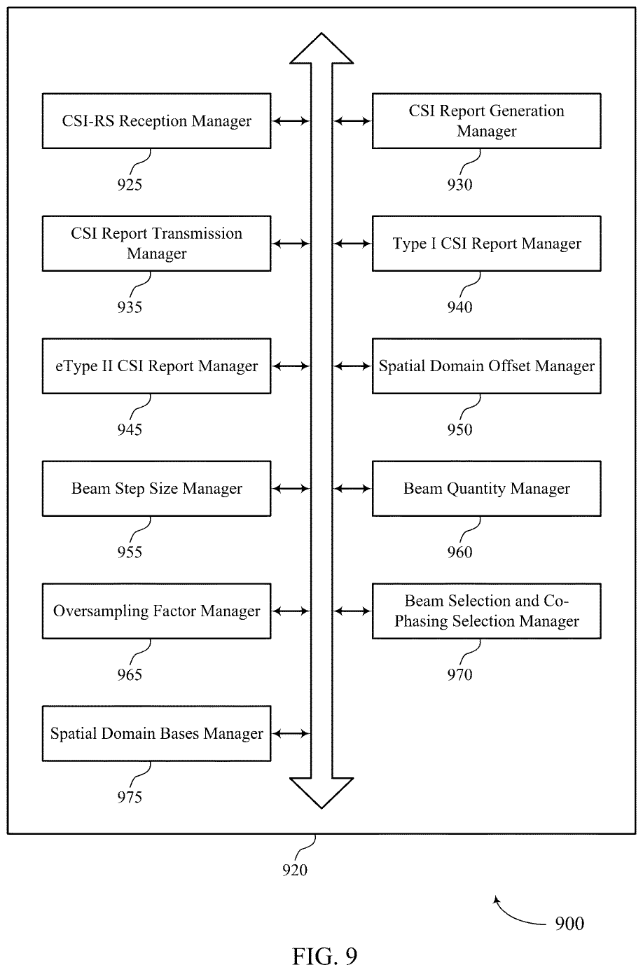

FIG. 9 shows a block diagram 900 of a communications manager 920 that supports channel state information codebook enhancements in accordance with one or more aspects of the present disclosure. The communications manager 920 may be an example of aspects of a communications manager 720, a communications manager 820, or both, as described herein. The communications manager 920, or various components thereof, may be an example of means for performing various aspects of channel state information codebook enhancements as described herein. For example, the communications manager 920 may include a CSI-RS reception manager 925, a CSI report generation manager 930, a CSI report transmission manager 935, a Type I CSI report manager 940, an eType II CSI report manager 945, a spatial domain offset manager 950, a beam step size manager 955, a beam quantity manager 960, an oversampling factor manager 965, a beam selection and co-phasing selection manager 970, a spatial domain bases manager 975, or any combination thereof. Each of these components, or components or subcomponents thereof (e.g., one or more processors, one or more memories), may communicate, directly or indirectly, with one another (e.g., via one or more buses).

The communications manager 920 may support wireless communications at a UE in accordance with examples as disclosed herein. The CSI-RS reception manager 925 is capable of, configured to, or operable to support a means for receiving, from a network entity, a set of CSI-RSs from a set of antenna ports at the network entity. The CSI report generation manager 930 is capable of, configured to, or operable to support a means for generating a channel state information report in accordance with a codebook, where a size of a downlink channel matrix estimated based on the set of CSI-RSs and used to generate the channel state information report is based on a quantity of antenna ports that is included in the set of antenna ports, and where at least one parameter of the codebook is based on the quantity of antenna ports exceeding a threshold. The CSI report transmission manager 935 is capable of, configured to, or operable to support a means for transmitting, to the network entity, the channel state information report.

In some examples, to support generating the channel state information report in accordance with the codebook, the Type I CSI report manager 940 is capable of, configured to, or operable to support a means for generating the channel state information report in accordance with a Type I single-panel codebook.

In some examples, to support generating the channel state information report in accordance with the Type I single-panel codebook, the spatial domain offset manager 950 is capable of, configured to, or operable to support a means for generating the channel state information report using a first spatial domain offset between layers of a precoding matrix, where the channel state information report is based on the precoding matrix, where the at least one parameter includes the first spatial domain offset, where a rank indication of the precoding matrix is between two layers and eight layers, and where the first spatial domain offset is larger than a second spatial domain offset associated with the quantity of antenna ports being at or below the threshold.

In some examples, to support generating the channel state information report in accordance with the Type I single-panel codebook, the spatial domain offset manager 950 is capable of, configured to, or operable to support a means for generating the channel state information report using a spatial domain offset between layers of a precoding matrix, where the channel state information report is based on the precoding matrix, where the at least one parameter includes the spatial domain offset, where a rank indication of the precoding matrix is between two layers and eight layers, and where a size of the spatial domain offset is based on a configuration of horizontal antenna elements and vertical antenna elements used to transmit the set of CSI-RSs.

In some examples, to support generating the channel state information report in accordance with the Type I single-panel codebook, the spatial domain offset manager 950 is capable of, configured to, or operable to support a means for generating the channel state information report using a first quantity of candidate spatial domain offsets between layers of a precoding matrix, where the channel state information report is based on the precoding matrix, where the at least one parameter includes the first quantity of candidate spatial domain offsets, where a rank indication of the precoding matrix is between two layers and four layers, and where the first quantity of candidate spatial domain offsets is larger than a second quantity of candidate spatial domain offsets associated with the quantity of antenna ports being at or below the threshold.

In some examples, to support generating the channel state information report in accordance with the Type I single-panel codebook, the beam step size manager 955 is capable of, configured to, or operable to support a means for generating the channel state information report using a first step size between beams of each beam group of a set of multiple beam groups associated with the Type I single-panel codebook, where the at least one parameter includes the first step size, and where the first step size is larger than a second step size associated with the quantity of antenna ports being at or below the threshold.

In some examples, to support generating the channel state information report in accordance with the Type I single-panel codebook, the beam quantity manager 960 is capable of, configured to, or operable to support a means for generating the channel state information report using a first quantity of beams within each of a set of multiple beam groups associated with the Type I single-panel codebook, where the at least one parameter includes the first quantity of beams, and where the first quantity of beams is larger than a second quantity of beams width associated with the Type I single-panel codebook associated with the quantity of antenna ports being at or below the threshold.

In some examples, to support generating the channel state information report in accordance with the Type I single-panel codebook, the oversampling factor manager 965 is capable of, configured to, or operable to support a means for generating the channel state information report using an oversampling factor, where a size of the oversampling factor is based on a rank of the channel state information report, where the at least one parameter includes the size of the oversampling factor.

In some examples, to support generating the channel state information report in accordance with the Type I single-panel codebook, the beam selection and co-phasing selection manager 970 is capable of, configured to, or operable to support a means for generating the channel state information report based on a respective beam selection and a respective co-phasing selection for each sub-band of a set of multiple sub-bands of the set of CSI-RSs, where a rank indication of a precoding matrix is between three layers and eight layers, where the channel state information report is based on the precoding matrix, and where the at least one parameter includes the respective beam selection and the respective co-phasing selection for each sub-band.

In some examples, to support generating the channel state information report in accordance with the codebook, the Type I CSI report manager 940 is capable of, configured to, or operable to support a means for generating the channel state information report in accordance with a Type I multi-panel codebook.

In some examples, to support generating the channel state information report in accordance with the Type I multi-panel codebook, the spatial domain offset manager 950 is capable of, configured to, or operable to support a means for generating the channel state information report using a first spatial domain offset between layers of a precoding matrix, where the channel state information report is based on the precoding matrix, where the at least one parameter includes the first spatial domain offset, where a rank indication of the precoding matrix is three or four layers, and where the first spatial domain offset is larger than a second spatial domain offset associated with the quantity of antenna ports being at or below the threshold.

In some examples, to support generating the channel state information report in accordance with the Type I multi-panel codebook, the spatial domain offset manager 950 is capable of, configured to, or operable to support a means for generating the channel state information report using a first quantity of candidate spatial domain offsets between layers of a precoding matrix, where the channel state information report is based on the precoding matrix, where the at least one parameter includes the first quantity of candidate spatial domain offsets, where a rank indication of the precoding matrix is between two layers and four layers, and where the first quantity of candidate spatial domain offsets is larger than a second quantity of candidate spatial domain offsets associated with the quantity of antenna ports being at or below the threshold.

In some examples, to support generating the channel state information report in accordance with the codebook, the eType II CSI report manager 945 is capable of, configured to, or operable to support a means for generating the channel state information report in accordance with an eType II single-panel codebook.

In some examples, to support generating the channel state information report in accordance with the eType II single-panel codebook, the spatial domain bases manager 975 is capable of, configured to, or operable to support a means for generating the channel state information report using a first quantity of spatial domain bases, where the at least one parameter includes the first quantity of spatial domain bases, and where the first quantity of spatial domain bases is larger than a second quantity of spatial domain bases associated with the quantity of antenna ports being at or below the threshold.

In some examples, to support generating the channel state information report in accordance with the codebook, the eType II CSI report manager 945 is capable of, configured to, or operable to support a means for generating the channel state information report in accordance with an eType II multi-panel codebook.

In some examples, to support generating the channel state information report in accordance with the eType II multi-panel codebook, the eType II CSI report manager 945 is capable of, configured to, or operable to support a means for generating the channel state information report using a same set of spatial domain bases for each panel of a set of multiple panels used to transmit the set of CSI-RSs.

In some examples, to support transmitting the CSI report, CSI report transmission manager 935 is capable of, configured to, or operable to support a means for transmitting the CSI report via an uplink control information, where an indication of the set of spatial domain bases are packed in group zero of part two of the UCI, where a set of non-zero coefficients for each layer are indicated in a group one or a group two of part two of the UCI, and where a quantity of non-zero coefficients of the set of non-zero coefficients for each layer is indicated in part one of the UCI.

In some examples, to support generating the channel state information report in accordance with the eType II multi-panel codebook, the eType II CSI report manager 945 is capable of, configured to, or operable to support a means for generating the channel state information report using a same set of spatial domain bases, a same set of frequency domain bases, and a different co-phasing value for each panel of a set of multiple panels used to transmit the set of CSI-RSs.

In some examples, to support transmitting the CSI report, CSI report transmission manager 935 is capable of, configured to, or operable to support a means for transmitting the CSI report via an uplink control information, where an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples, to support generating the channel state information report in accordance with the eType II multi-panel codebook, the eType II CSI report manager 945 is capable of, configured to, or operable to support a means for generating the channel state information report using a same set of non-zero coefficients for each panel of the set of multiple panels.

In some examples, the threshold is thirty-two antenna ports.

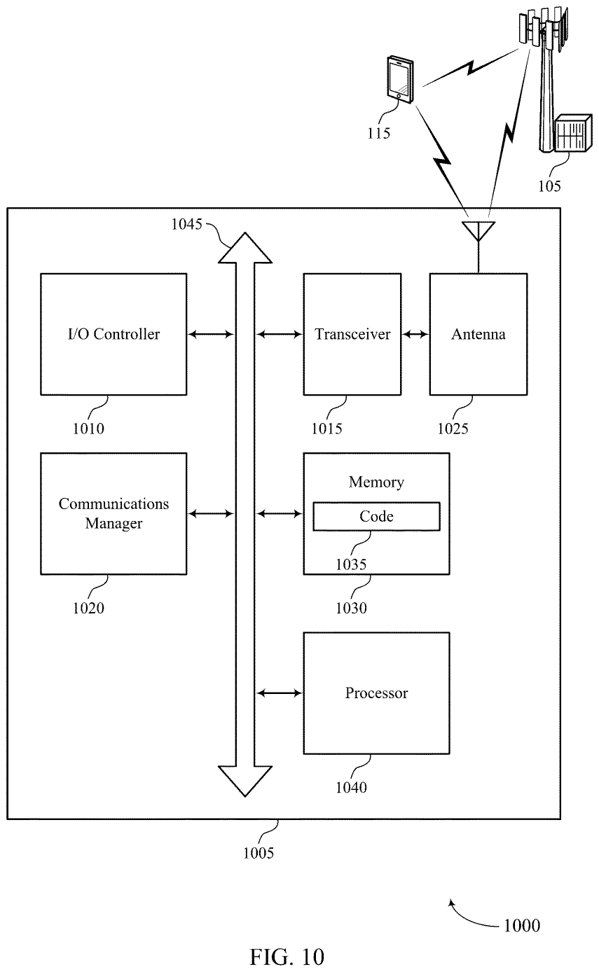

FIG. 10 shows a diagram of a system 1000 including a device 1005 that supports channel state information codebook enhancements in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another Type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate one or more memory arrays using at least one memory controller. In some other cases, at least one memory controller may be integrated into the at least one processor 1040. The at least one processor 1040 may be configured to execute computer-readable instructions stored in memory (e.g., the at least one memory 1030) to cause the device 1005 to perform various functions (e.g., functions or tasks supporting channel state information codebook enhancements). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications at a UE in accordance with examples as disclosed herein. For example, the communications manager 1020 is capable of, configured to, or operable to support a means for receiving, from a network entity, a set of CSI-RSs from a set of antenna ports at the network entity. The communications manager 1020 is capable of, configured to, or operable to support a means for generating a channel state information report in accordance with a codebook, where a size of a downlink channel matrix estimated based on the set of CSI-RSs and used to generate the channel state information report is based on a quantity of antenna ports that is included in the set of antenna ports, and where at least one parameter of the codebook is based on the quantity of antenna ports exceeding a threshold. The communications manager 1020 is capable of, configured to, or operable to support a means for transmitting, to the network entity, the channel state information report.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of channel state information codebook enhancements as described herein, or the at least one processor 1040 and the at least one memory 1030 may be otherwise configured to, individually or collectively, perform or support such operations.

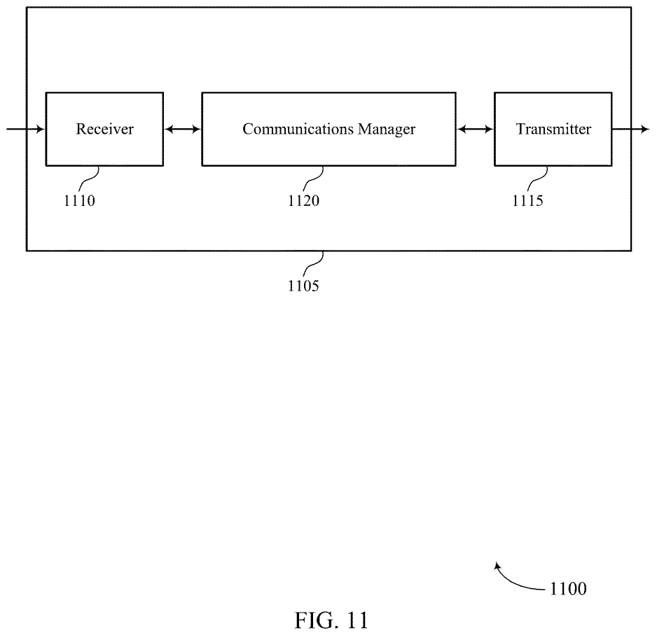

FIG. 11 shows a block diagram 1100 of a device 1105 that supports channel state information codebook enhancements in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of channel state information codebook enhancements as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 is capable of, configured to, or operable to support a means for transmitting, to a UE, a set of CSI-RSs using a set of antenna ports. The communications manager 1120 is capable of, configured to, or operable to support a means for receiving, from the UE, a channel state information report generated at the UE in accordance with a codebook, where a size of a downlink channel matrix indicated by the channel state information report is based on a quantity of antenna ports that is included in the set of antenna ports used to transmit the set of CSI-RSs, and where at least one parameter of the codebook is based on the quantity of antenna ports exceeding a threshold.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

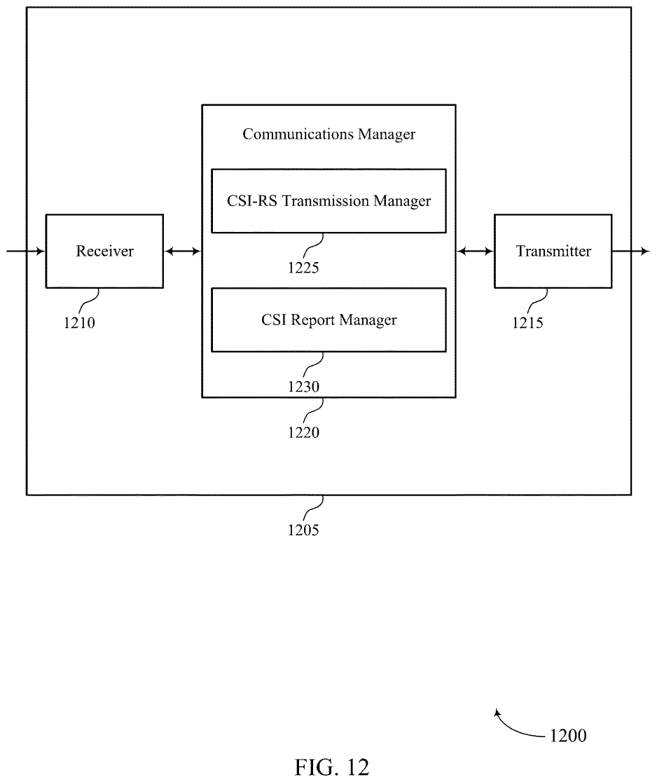

FIG. 12 shows a block diagram 1200 of a device 1205 that supports channel state information codebook enhancements in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of channel state information codebook enhancements as described herein. For example, the communications manager 1220 may include a CSI-RS transmission manager 1225 a CSI report manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The CSI-RS transmission manager 1225 is capable of, configured to, or operable to support a means for transmitting, to a UE, a set of CSI-RSs using a set of antenna ports. The CSI report manager 1230 is capable of, configured to, or operable to support a means for receiving, from the UE, a channel state information report generated at the UE in accordance with a codebook, where a size of a downlink channel matrix indicated by the channel state information report is based on a quantity of antenna ports that is included in the set of antenna ports used to transmit the set of CSI-RSs, and where at least one parameter of the codebook is based on the quantity of antenna ports exceeding a threshold.

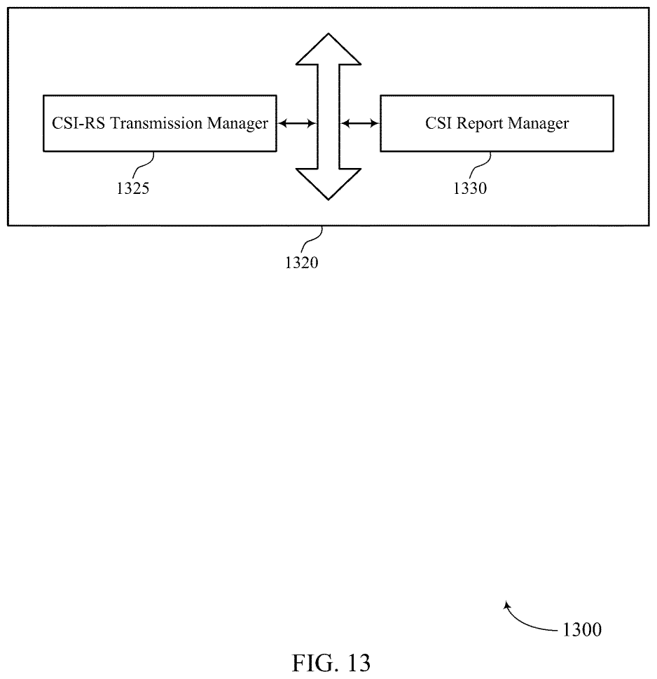

FIG. 13 shows a block diagram 1300 of a communications manager 1320 that supports channel state information codebook enhancements in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of channel state information codebook enhancements as described herein. For example, the communications manager 1320 may include a CSI-RS transmission manager 1325 a CSI report manager 1330, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The CSI-RS transmission manager 1325 is capable of, configured to, or operable to support a means for transmitting, to a UE, a set of CSI-RSs using a set of antenna ports. The CSI report manager 1330 is capable of, configured to, or operable to support a means for receiving, from the UE, a channel state information report generated at the UE in accordance with a codebook, where a size of a downlink channel matrix indicated by the channel state information report is based on a quantity of antenna ports that is included in the set of antenna ports used to transmit the set of CSI-RSs, and where at least one parameter of the codebook is based on the quantity of antenna ports exceeding a threshold.

In some examples, the codebook is a Type I single-panel codebook.

In some examples, the at least one parameter includes a first spatial domain offset between layers of a precoding matrix. In some examples, the channel state information report is based on the precoding matrix. In some examples, a rank indication of the precoding matrix is between two layers and eight layers. In some examples, the first spatial domain offset is larger than a second spatial domain offset associated with the quantity of antenna ports being at or below the threshold.

In some examples, the at least one parameter includes a spatial domain offset between layers of a precoding matrix. In some examples, the channel state information report is based on the precoding matrix. In some examples, a rank indication of the precoding matrix is between two layers and eight layers. In some examples, a size of the spatial domain offset is based on a configuration of horizontal antenna elements and vertical antenna elements used to transmit the set of CSI-RSs.

In some examples, the at least one parameter includes a first quantity of candidate spatial domain offsets between layers of a precoding matrix. In some examples, the channel state information report is based on the precoding matrix. In some examples, a rank indication of the precoding matrix is between two layers and four layers. In some examples, the first quantity of candidate spatial domain offsets is larger than a second quantity of candidate spatial domain offsets associated with the quantity of antenna ports being at or below the threshold.

In some examples, the at least one parameter includes a first step size between beams of each beam group of a set of multiple beam groups associated with the Type I single-panel codebook. In some examples, the first step size is larger than a second step size associated with the quantity of antenna ports being at or below the threshold.

In some examples, the at least one parameter includes a first quantity of beams within each of a set of multiple beam groups associated with the Type I single-panel codebook. In some examples, the first quantity of beams is larger than a second quantity of beams width associated with the Type I single-panel codebook associated with the quantity of antenna ports being at or below the threshold.

In some examples, the at least one parameter includes an oversampling factor. In some examples, a size of the oversampling factor is based on a rank of the channel state information report.

In some examples, the at least one parameter includes a respective beam selection and a respective co-phasing selection for each sub-band of a set of multiple sub-bands of the set of CSI-RSs. In some examples, a rank indication of a precoding matrix is between three layers and eight layers. In some examples, the channel state information report is based on the precoding matrix.

In some examples, the codebook is a Type I multi-panel codebook.

In some examples, the at least one parameter includes a first spatial domain offset between layers of a precoding matrix. In some examples, the channel state information report is based on the precoding matrix. In some examples, a rank indication of the precoding matrix is three or four layers. In some examples, the first spatial domain offset is larger than a second spatial domain offset associated with the quantity of antenna ports being at or below the threshold.

In some examples, the at least one parameter includes a first quantity of candidate spatial domain offsets between layers of a precoding matrix. In some examples, the at least one parameter includes a first quantity of candidate spatial domain offsets between layers of a precoding matrix. In some examples, the channel state information report is based on the precoding matrix. In some examples, a rank indication of the precoding matrix is between two layers and four layers. In some examples, the first quantity of candidate spatial domain offsets is larger than a second quantity of candidate spatial domain offsets associated with the quantity of antenna ports being at or below the threshold.

In some examples, the codebook is an eType II single-panel codebook.

In some examples, the at least one parameter includes a first quantity of spatial domain bases. In some examples, the first quantity of spatial domain bases is larger than a second quantity of spatial domain bases associated with the quantity of antenna ports being at or below the threshold.

In some examples, the codebook is an eType II multi-panel codebook.

In some examples, the at least one parameter includes use of a same set of spatial domain bases for each panel of a set of multiple panels used to transmit the set of CSI-RSs.

In some examples, the CSI report is received via a UCI, where an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples, the at least one parameter includes use of a same set of spatial domain bases, a same set of frequency domain bases, and a different co-phasing value for each panel of a set of multiple panels used to transmit the set of CSI-RSs.

In some examples, the CSI report is received via a UCI, where an indication of the set of spatial domain bases are packed in group zero of part two of the UCI, where the different co-phasing value for each panel is reported in the group zero or a group one of part two of the UCI, where a set of non-zero coefficients are indicated in the group one or a group two of part two of the UCI, and where a quantity of non-zero coefficients of the set of non-zero coefficients is indicated in part one of the UCI.

In some examples, the at least one parameter includes use of a same set of non-zero coefficients for each panel of the set of multiple panels.

In some examples, the threshold is thirty-two antenna ports.

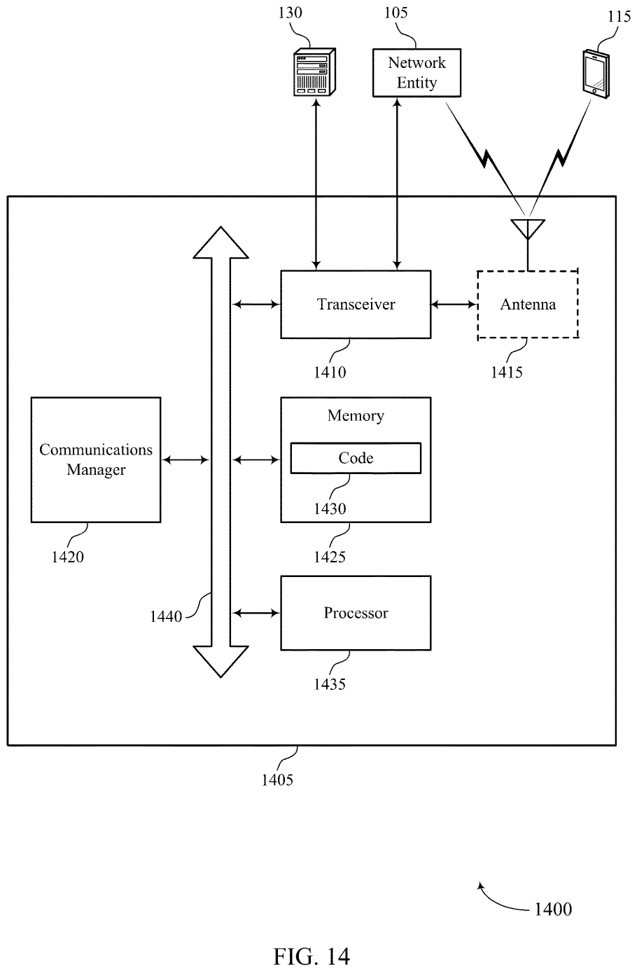

FIG. 14 shows a diagram of a system 1400 including a device 1405 that supports channel state information codebook enhancements in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another Type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate one or more memory arrays using at least one memory controller. In some other cases, at least one memory controller may be integrated into one or more of the at least one processor 1435. The at least one processor 1435 may be configured to execute computer-readable instructions stored in memory (e.g., one or more of the at least one memory 1425) to cause the device 1405 to perform various functions (e.g., functions or tasks supporting channel state information codebook enhancements). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. The processing system of the device 1405 may interface with other components of the device 1405 and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105 and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 is capable of, configured to, or operable to support a means for transmitting, to a UE, a set of CSI-RSs using a set of antenna ports. The communications manager 1420 is capable of, configured to, or operable to support a means for receiving, from the UE, a channel state information report generated at the UE in accordance with a codebook, where a size of a downlink channel matrix indicated by the channel state information report is based on a quantity of antenna ports that is included in the set of antenna ports used to transmit the set of CSI-RSs, and where at least one parameter of the codebook is based on the quantity of antenna ports exceeding a threshold.

By including or configuring the communications manager 1420 in accordance with examples as described herein, the device 1405 may support techniques for improved communication reliability, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of channel state information codebook enhancements as described herein, or the at least one processor 1435 and the at least one memory 1425 may be otherwise configured to, individually or collectively, perform or support such operations.

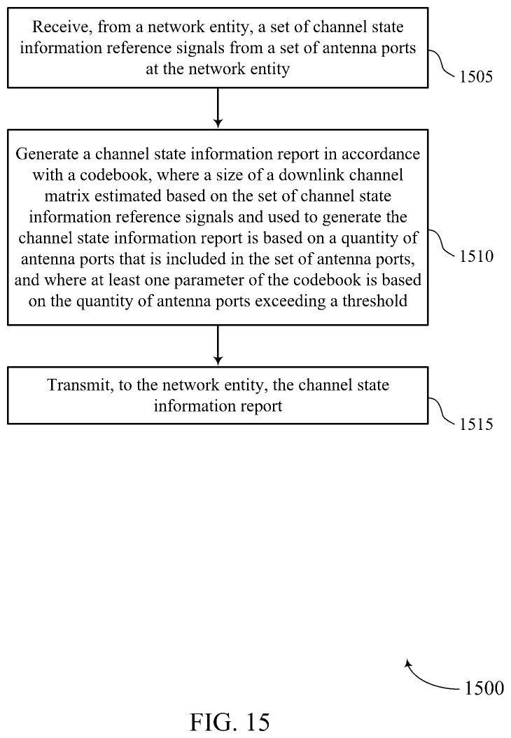

FIG. 15 shows a flowchart illustrating a method 1500 that supports channel state information codebook enhancements in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a set of CSI-RSs from a set of antenna ports at the network entity. The operations of block 1505 may be performed in accordance with examples as disclosed herein. In some examples, aspects of the operations of 1505 may be performed by a CSI-RS reception manager 925 as described with reference to FIG. 9. Additionally or alternatively, means for performing 1505 may, but not necessarily, include, for example, antenna 1025, transceiver 1015, communications manager 1020, memory 1030 (including code 1035), processor 1040 and/or bus 1045.

At 1510, the method may include generating a channel state information report in accordance with a codebook, where a size of a downlink channel matrix estimated based on the set of CSI-RSs and used to generate the channel state information report is based on a quantity of antenna ports that is included in the set of antenna ports, and where at least one parameter of the codebook is based on the quantity of antenna ports exceeding a threshold. The operations of block 1510 may be performed in accordance with examples as disclosed herein. In some examples, aspects of the operations of 1510 may be performed by a CSI report generation manager 930 as described with reference to FIG. 9. Additionally or alternatively, means for performing 1510 may, but not necessarily, include, for example, antenna 1025, transceiver 1015, communications manager 1020, memory 1030 (including code 1035), processor 1040 and/or bus 1045.

At 1515, the method may include transmitting, to the network entity, the channel state information report. The operations of block 1515 may be performed in accordance with examples as disclosed herein. In some examples, aspects of the operations of 1515 may be performed by a CSI report transmission manager 935 as described with reference to FIG. 9. Additionally or alternatively, means for performing 1515 may, but not necessarily, include, for example, antenna 1025, transceiver 1015, communications manager 1020, memory 1030 (including code 1035), processor 1040 and/or bus 1045.

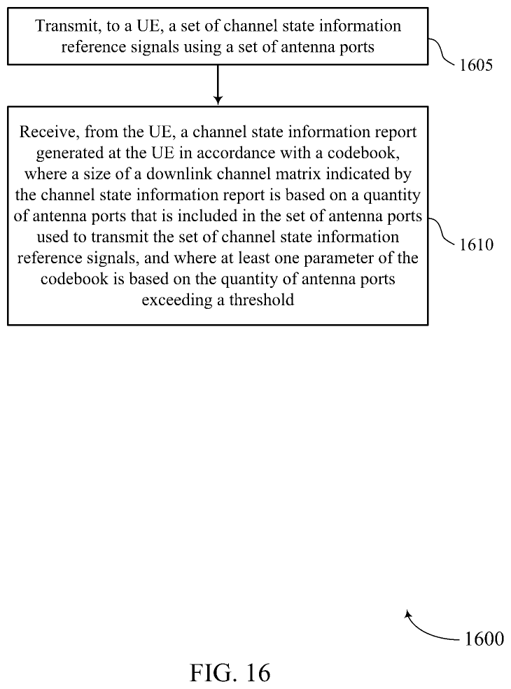

FIG. 16 shows a flowchart illustrating a method 1600 that supports channel state information codebook enhancements in accordance with aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a set of CSI-RSs using a set of antenna ports. The operations of block 1605 may be performed in accordance with examples as disclosed herein. In some examples, aspects of the operations of 1605 may be performed by a CSI-RS transmission manager 1325 as described with reference to FIG. 13. Additionally or alternatively, means for performing 1605 may, but not necessarily, include, for example, antenna 1415, transceiver 1410, communications manager 1420, memory 1425 (including code 1430), processor 1435 and/or bus 1440.

At 1610, the method may include receiving, from the UE, a channel state information report generated at the UE in accordance with a codebook, where a size of a downlink channel matrix indicated by the channel state information report is based on a quantity of antenna ports that is included in the set of antenna ports used to transmit the set of CSI-RSs, and where at least one parameter of the codebook is based on the quantity of antenna ports exceeding a threshold. The operations of block 1610 may be performed in accordance with examples as disclosed herein. In some examples, aspects of the operations of 1610 may be performed by a CSI report manager 1330 as described with reference to FIG. 13. Additionally or alternatively, means for performing 1610 may, but not necessarily, include, for example, antenna 1415, transceiver 1410, communications manager 1420, memory 1425 (including code 1430), processor 1435 and/or bus 1440.

The following provides an overview of aspects of the present disclosure:

Aspect 1: A method for wireless communications at a UE, comprising: receiving, from a network entity, a set of CSI-RSs from a set of antenna ports at the network entity; generating a CSI report in accordance with a codebook, wherein a size of a downlink channel matrix estimated based on the set of CSI-RSs and used to generate the CSI report is based at least in part on a quantity of antenna ports that is included in the set of antenna ports, and wherein at least one parameter of the codebook is based at least in part on the quantity of antenna ports exceeding a threshold; and transmitting, to the network entity, the CSI report.

Aspect 2: The method of aspect 1, wherein generating the CSI report in accordance with the codebook comprises: generating the CSI report in accordance with a Type I single-panel codebook.

Aspect 3: The method of aspect 2, wherein generating the CSI report in accordance with the Type I single-panel codebook comprises: generating the CSI report using a first spatial domain offset between layers of a precoding matrix, wherein the CSI report is based at least in part on the precoding matrix, wherein the at least one parameter comprises the first spatial domain offset, wherein a rank indication of the precoding matrix is between two layers and eight layers, and wherein the first spatial domain offset is larger than a second spatial domain offset associated with the quantity of antenna ports being at or below the threshold.

Aspect 4: The method of any of aspects 2 through 3, wherein generating the CSI report in accordance with the Type I single-panel codebook comprises: generating the CSI report using a spatial domain offset between layers of a precoding matrix, wherein the CSI report is based at least in part on the precoding matrix, wherein the at least one parameter comprises the spatial domain offset, wherein a rank indication of the precoding matrix is between two layers and eight layers, and wherein a size of the spatial domain offset is based at least in part on a configuration of horizontal antenna elements and vertical antenna elements used to transmit the set of CSI-RSs.

Aspect 5: The method of any of aspects 2 through 4, wherein generating the CSI report in accordance with the Type I single-panel codebook comprises: generating the CSI report using a first quantity of candidate spatial domain offsets between layers of a precoding matrix, wherein the CSI report is based at least in part on the precoding matrix, wherein the at least one parameter comprises the first quantity of candidate spatial domain offsets, wherein a rank indication of the precoding matrix is between two layers and four layers, and wherein the first quantity of candidate spatial domain offsets is larger than a second quantity of candidate spatial domain offsets associated with the quantity of antenna ports being at or below the threshold.

Aspect 6: The method of any of aspects 2 through 5, wherein generating the CSI report in accordance with the Type I single-panel codebook comprises: generating the CSI report using a first step size between beams of each beam group of a plurality of beam groups associated with the Type I single-panel codebook, wherein the at least one parameter comprises the first step size, and wherein the first step size is larger than a second step size associated with the quantity of antenna ports being at or below the threshold.

Aspect 7: The method of any of aspects 2 through 6, wherein generating the CSI report in accordance with the Type I single-panel codebook comprises: generating the CSI report using a first quantity of beams within each of a plurality of beam groups associated with the Type I single-panel codebook, wherein the at least one parameter comprises the first quantity of beams, and wherein the first quantity of beams is larger than a second quantity of beams width associated with the Type I single-panel codebook associated with the quantity of antenna ports being at or below the threshold.

Aspect 8: The method of any of aspects 2 through 7, wherein generating the CSI report in accordance with the Type I single-panel codebook comprises: generating the CSI report using an oversampling factor, wherein a size of the oversampling factor is based at least in part on a rank of the CSI report, wherein the at least one parameter comprises the size of the oversampling factor.

Aspect 9: The method of any of aspects 2 through 8, wherein generating the CSI report in accordance with the Type I single-panel codebook comprises: generating the CSI report based on a respective beam selection and a respective co-phasing selection for each sub-band of a plurality of sub-bands of the set of CSI-RSs, wherein a rank indication of a precoding matrix is between three layers and eight layers, wherein the CSI report is based at least in part on the precoding matrix, and wherein the at least one parameter comprises the respective beam selection and the respective co-phasing selection for each sub-band.

Aspect 10: The method of aspect 1, wherein generating the CSI report in accordance with the codebook comprises: generating the CSI report in accordance with a Type I multi-panel codebook.

Aspect 11: The method of aspect 10, wherein generating the CSI report in accordance with the Type I multi-panel codebook comprises: generating the CSI report using a first spatial domain offset between layers of a precoding matrix, wherein the CSI report is based at least in part on the precoding matrix, wherein the at least one parameter comprises the first spatial domain offset, wherein a rank indication of the precoding matrix is three or four layers, and wherein the first spatial domain offset is larger than a second spatial domain offset associated with the quantity of antenna ports being at or below the threshold.

Aspect 12: The method of any of aspects 10 through 11, wherein generating the CSI report in accordance with the Type I multi-panel codebook comprises: generating the CSI report using a first quantity of candidate spatial domain offsets between layers of a precoding matrix, wherein the CSI report is based at least in part on the precoding matrix, wherein the at least one parameter comprises the first quantity of candidate spatial domain offsets, wherein a rank indication of the precoding matrix is between two layers and four layers, and wherein the first quantity of candidate spatial domain offsets is larger than a second quantity of candidate spatial domain offsets associated with the quantity of antenna ports being at or below the threshold.

Aspect 13: The method of aspect 1, wherein generating the CSI report in accordance with the codebook comprises: generating the CSI report in accordance with an eType II single-panel codebook.

Aspect 14: The method of aspect 13, wherein generating the CSI report in accordance with the eType II single-panel codebook comprises: generating the CSI report using a first quantity of spatial domain bases, wherein the at least one parameter comprises the first quantity of spatial domain bases, and wherein the first quantity of spatial domain bases is larger than a second quantity of spatial domain bases associated with the quantity of antenna ports being at or below the threshold.

Aspect 15: The method of aspect 1, wherein generating the CSI report in accordance with the codebook comprises: generating the CSI report in accordance with an eType II multi-panel codebook.

Aspect 16: The method of aspect 15, wherein generating the CSI report in accordance with the eType II multi-panel codebook comprises: generating the CSI report using a same set of spatial domain bases for each panel of a plurality of panels used to transmit the set of CSI-RSs.

Aspect 17: The method of aspect 16, wherein transmitting the CSI report comprises: transmitting the CSI report via an UCI, wherein an indication of the set of spatial domain bases are packed in group zero of part two of the UCI, wherein a set of non-zero coefficients for each layer are indicated in a group one or a group two of part two of the UCI, and wherein a quantity of non-zero coefficients of the set of non-zero coefficients for each layer is indicated in part one of the UCI.

Aspect 18: The method of any of aspects 15 through 16, wherein generating the CSI report in accordance with the eType II multi-panel codebook comprises: generating the CSI report using a same set of spatial domain bases, a same set of frequency domain bases, and a different co-phasing value for each panel of a plurality of panels used to transmit the set of CSI-RSs.

Aspect 19: The method of aspect 18, wherein transmitting the CSI report comprises: transmitting the CSI report via an UCI, wherein an indication of the set of spatial domain bases are packed in group zero of part two of the UCI, wherein the different co-phasing value for each panel is reported in the group zero or a group one of part two of the UCI, wherein a set of non-zero coefficients are indicated in the group one or a group two of part two of the UCI, and wherein a quantity of non-zero coefficients of the set of non-zero coefficients is indicated in part one of the UCI.

Aspect 20: The method of aspect 18, wherein generating the CSI report in accordance with the eType II multi-panel codebook further comprises: generating the CSI report using a same set of non-zero coefficients for each panel of the plurality of panels.

Aspect 21: The method of aspect 20, wherein transmitting the CSI report comprises: transmitting the CSI report via an UCI, wherein an indication of the set of spatial domain bases are packed in group zero of part two of the UCI, wherein the different co-phasing value for each panel is reported in the group zero or a group one of part two of the UCI, wherein a set of non-zero coefficients are indicated in the group one or a group two of part two of the UCI, and wherein a quantity of non-zero coefficients of the set of non-zero coefficients is indicated in part one of the UCI.

Aspect 22: The method of any of aspects 1 through 20, wherein the threshold is thirty-two antenna ports.

Aspect 23: A method for wireless communications at a network entity, comprising: transmitting, to a UE, a set of CSI-RSs using a set of antenna ports; and receiving, from the UE, a CSI report generated at the UE in accordance with a codebook, wherein a size of a downlink channel matrix indicated by the CSI report is based at least in part on a quantity of antenna ports that is included in the set of antenna ports used to transmit the set of CSI-RSs, and wherein at least one parameter of the codebook is based at least in part on the quantity of antenna ports exceeding a threshold.

Aspect 24: The method of aspect 23, wherein the codebook is a Type I single-panel codebook.

Aspect 25: The method of aspect 24, wherein the at least one parameter comprises a first spatial domain offset between layers of a precoding matrix, the CSI report is based at least in part on the precoding matrix, a rank indication of the precoding matrix is between two layers and eight layers, and the first spatial domain offset is larger than a second spatial domain offset associated with the quantity of antenna ports being at or below the threshold.

Aspect 26: The method of any of aspects 24 through 25, wherein the at least one parameter comprises a spatial domain offset between layers of a precoding matrix, the CSI report is based at least in part on the precoding matrix, a rank indication of the precoding matrix is between two layers and eight layers, and a size of the spatial domain offset is based at least in part on a configuration of horizontal antenna elements and vertical antenna elements used to transmit the set of CSI-RSs.

Aspect 27: The method of any of aspects 24 through 26, wherein the at least one parameter comprises a first quantity of candidate spatial domain offsets between layers of a precoding matrix, the CSI report is based at least in part on the precoding matrix, a rank indication of the precoding matrix is between two layers and four layers, and the first quantity of candidate spatial domain offsets is larger than a second quantity of candidate spatial domain offsets associated with the quantity of antenna ports being at or below the threshold.

Aspect 28: The method of any of aspects 24 through 27, wherein the at least one parameter comprises a first step size between beams of each beam group of a plurality of beam groups associated with the Type I single-panel codebook, and the first step size is larger than a second step size associated with the quantity of antenna ports being at or below the threshold.

Aspect 29: The method of any of aspects 24 through 28, wherein the at least one parameter comprises a first quantity of beams within each of a plurality of beam groups associated with the Type I single-panel codebook, and the first quantity of beams is larger than a second quantity of beams width associated with the Type I single-panel codebook associated with the quantity of antenna ports being at or below the threshold.

Aspect 30: The method of any of aspects 24 through 29, wherein the at least one parameter comprises an oversampling factor, and a size of the oversampling factor is based at least in part on a rank of the CSI report.

Aspect 31: The method of any of aspects 24 through 30, wherein the at least one parameter comprises a respective beam selection and a respective co-phasing selection for each sub-band of a plurality of sub-bands of the set of CSI-RSs, a rank indication of a precoding matrix is between three layers and eight layers, and the CSI report is based at least in part on the precoding matrix.

Aspect 32: The method of aspect 23, wherein the codebook is a Type I multi-panel codebook.

Aspect 33: The method of aspect 32, wherein the at least one parameter comprises a first spatial domain offset between layers of a precoding matrix, the CSI report is based at least in part on the precoding matrix, a rank indication of the precoding matrix is three or four layers, and the first spatial domain offset is larger than a second spatial domain offset associated with the quantity of antenna ports being at or below the threshold.

Aspect 34: The method of any of aspects 32 through 33, wherein the at least one parameter comprises a first quantity of candidate spatial domain offsets between layers of a precoding matrix, the at least one parameter comprises a first quantity of candidate spatial domain offsets between layers of a precoding matrix, the CSI report is based at least in part on the precoding matrix, a rank indication of the precoding matrix is between two layers and four layers, and the first quantity of candidate spatial domain offsets is larger than a second quantity of candidate spatial domain offsets associated with the quantity of antenna ports being at or below the threshold.

Aspect 35: The method of aspect 23, wherein the codebook is an eType II single-panel codebook.

Aspect 36: The method of aspect 35, wherein the at least one parameter comprises a first quantity of spatial domain bases, and the first quantity of spatial domain bases is larger than a second quantity of spatial domain bases associated with the quantity of antenna ports being at or below the threshold.

Aspect 37: The method of aspect 23, wherein the codebook is an eType II multi-panel codebook.

Aspect 38: The method of aspect 37, wherein the at least one parameter comprises use of a same set of spatial domain bases for each panel of a plurality of panels used to transmit the set of CSI-RSs.

Aspect 39: The method of aspect 38, wherein the CSI report is received via an UCI, wherein an indication of the set of spatial domain bases are packed in group zero of part two of the UCI, wherein a set of non-zero coefficients for each layer are indicated in a group one or a group two of part two of the UCI, and wherein a quantity of non-zero coefficients of the set of non-zero coefficients for each layer is indicated in part one of the UCI.

Aspect 40: The method of any of aspects 37 through 38, wherein the at least one parameter comprises use of a same set of spatial domain bases, a same set of frequency domain bases, and a different co-phasing value for each panel of a plurality of panels used to transmit the set of CSI-RSs.

Aspect 41: The method of aspect 40, wherein the CSI report is received via an UCI, wherein an indication of the set of spatial domain bases are packed in group zero of part two of the UCI, wherein the different co-phasing value for each panel is reported in the group zero or a group one of part two of the UCI, wherein a set of non-zero coefficients are indicated in the group one or a group two of part two of the UCI, and wherein a quantity of non-zero coefficients of the set of non-zero coefficients is indicated in part one of the UCI.

Aspect 42: The method of aspect 40, wherein the at least one parameter comprises use of a same set of non-zero coefficients for each panel of the plurality of panels.

Aspect 43: The method of aspect 42, wherein the CSI report is received via an UCI, wherein an indication of the set of spatial domain bases are packed in group zero of part two of the UCI, wherein the different co-phasing value for each panel is reported in the group zero or a group one of part two of the UCI, wherein a set of non-zero coefficients are indicated in the group one or a group two of part two of the UCI, and wherein a quantity of non-zero coefficients of the set of non-zero coefficients is indicated in part one of the UCI.

Aspect 44: The method of any of aspects 23 through 42, wherein the threshold is thirty-two antenna ports.

Aspect 45: An apparatus for wireless communications, comprising memory, a transceiver, and at least one processor of a UE coupled with the memory and processor and configured to perform a method of any of aspects 1 through 22.

Aspect 46: An apparatus for wireless communications at a UE, comprising at least one means for performing a method of any of aspects 1 through 22.

Aspect 47: A non-transitory computer-readable medium storing code for wireless communications at a UE, the code comprising instructions executable by a processor to perform a method of any of aspects 1 through 22.

Aspect 48: An apparatus for wireless communications, comprising memory and at least one processor of a network entity coupled with the memory and configured to perform a method of any of aspects 23 through 44.

Aspect 49: An apparatus for wireless communications at a network entity, comprising at least one means for performing a method of any of aspects 23 through 44.

Aspect 50: A non-transitory computer-readable medium storing code for wireless communications at a network entity, the code comprising instructions executable by a processor to perform a method of any of aspects 23 through 44.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by memory or a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same Type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications, comprising:
memory;
a transceiver; and
at least one processor of a user equipment (UE), the at least one processor coupled with the memory and the transceiver and configured to:
receive, via the transceiver from a network entity, a set of channel state information reference signals from a set of antenna ports at the network entity;
generate a channel state information report in accordance with a codebook, wherein a size of a downlink channel matrix estimated based on the set of channel state information reference signals and used to generate the channel state information report is based at least in part on a quantity of antenna ports that is included in the set of antenna ports, and wherein at least one parameter of the codebook is based at least in part on the quantity of antenna ports exceeding a threshold; and
transmit, via the transceiver to the network entity, the channel state information report.

2. The apparatus of claim 1, wherein, to generate the channel state information report in accordance with the codebook, the at least one processor is configured to:
generate the channel state information report in accordance with a Type I single-panel codebook.

3. The apparatus of claim 2, wherein, to generate the channel state information report in accordance with the Type I single-panel codebook, the at least one processor is configured to:
generate the channel state information report using a first spatial domain offset between layers of a precoding matrix, wherein the channel state information report is based at least in part on the precoding matrix, wherein the at least one parameter comprises the first spatial domain offset, wherein a rank indication of the precoding matrix is between two layers and eight layers, and wherein the first spatial domain offset is larger than a second spatial domain offset associated with the quantity of antenna ports being at or below the threshold.

4. The apparatus of claim 2, wherein, to generate the channel state information report in accordance with the Type I single-panel codebook, the at least one processor is further configured to:
generate the channel state information report using a spatial domain offset between layers of a precoding matrix, wherein the channel state information report is based at least in part on the precoding matrix, wherein the at least one parameter comprises the spatial domain offset, wherein a rank indication of the precoding matrix is between two layers and eight layers, and wherein a size of the spatial domain offset is based at least in part on a configuration of horizontal antenna elements and vertical antenna elements used to transmit the set of channel state information reference signals.

5. The apparatus of claim 2, wherein, to generate the channel state information report in accordance with the Type I single-panel codebook, the at least one processor is further configured to:
generate the channel state information report using a first quantity of candidate spatial domain offsets between layers of a precoding matrix, wherein the channel state information report is based at least in part on the precoding matrix, wherein the at least one parameter comprises the first quantity of candidate spatial domain offsets, wherein a rank indication of the precoding matrix is between two layers and four layers, and wherein the first quantity of candidate spatial domain offsets is larger than a second quantity of candidate spatial domain offsets associated with the quantity of antenna ports being at or below the threshold.

6. The apparatus of claim 2, wherein, to generate the channel state information report in accordance with the Type I single-panel codebook, the at least one processor is further configured to:
generate the channel state information report using a first step size between beams of each beam group of a plurality of beam groups associated with the Type I single-panel codebook, wherein the at least one parameter comprises the first step size, and wherein the first step size is larger than a second step size associated with the quantity of antenna ports being at or below the threshold.

7. The apparatus of claim 2, wherein, to generate the channel state information report in accordance with the Type I single-panel codebook, the at least one processor is further configured to:
generate the channel state information report using a first quantity of beams within each of a plurality of beam groups associated with the Type I single-panel codebook, wherein the at least one parameter comprises the first quantity of beams, and wherein the first quantity of beams is larger than a second quantity of beams width associated with the Type I single-panel codebook associated with the quantity of antenna ports being at or below the threshold.

8. The apparatus of claim 2, wherein, to generate the channel state information report in accordance with the Type I single-panel codebook, the at least one processor is further configured to:
generate the channel state information report using an oversampling factor, wherein a size of the oversampling factor is based at least in part on a rank of the channel state information report, wherein the at least one parameter comprises the size of the oversampling factor.

9. The apparatus of claim 2, wherein, to generate the channel state information report in accordance with the Type I single-panel codebook, the at least one processor is further configured to:
generate the channel state information report based on a respective beam selection and a respective co-phasing selection for each sub-band of a plurality of sub-bands of the set of channel state information reference signals, wherein a rank indication of a precoding matrix is between three layers and eight layers, wherein the channel state information report is based at least in part on the precoding matrix, and wherein the at least one parameter comprises the respective beam selection and the respective co-phasing selection for each sub-band.

10. (canceled)

11. The apparatus of claim 1, wherein, to generate the channel state information report in accordance with the codebook, the at least one processor is configured to generate the channel state information report in accordance with a Type I multi-panel codebook and is further configured to:
generate the channel state information report using a first spatial domain offset between layers of a precoding matrix, wherein the channel state information report is based at least in part on the precoding matrix, wherein the at least one parameter comprises the first spatial domain offset, wherein a rank indication of the precoding matrix is three or four layers, and wherein the first spatial domain offset is larger than a second spatial domain offset associated with the quantity of antenna ports being at or below the threshold.

12. The apparatus of claim 1, wherein, to generate the channel state information report in accordance with the codebook, the at least one processor is configured to generate the channel state information report in accordance with a Type I multi-panel codebook and is further configured to:
generate the channel state information report using a first quantity of candidate spatial domain offsets between layers of a precoding matrix, wherein the channel state information report is based at least in part on the precoding matrix, wherein the at least one parameter comprises the first quantity of candidate spatial domain offsets, wherein a rank indication of the precoding matrix is between two layers and four layers, and wherein the first quantity of candidate spatial domain offsets is larger than a second quantity of candidate spatial domain offsets associated with the quantity of antenna ports being at or below the threshold.

13. The apparatus of claim 1, wherein, to generate the channel state information report in accordance with the codebook, the at least one processor is further configured to:
generate the channel state information report in accordance with an Enhanced Type II single-panel codebook, and
generate the channel state information report using a first quantity of spatial domain bases, wherein the at least one parameter comprises the first quantity of spatial domain bases, and wherein the first quantity of spatial domain bases is larger than a second quantity of spatial domain bases associated with the quantity of antenna ports being at or below the threshold.

14. (canceled)

15. The apparatus of claim 1, wherein, to generate the channel state information report in accordance with the codebook, the at least one processor is further configured to:
generate the channel state information report in accordance with an Enhanced Type II multi-panel codebook; and
generate the channel state information report using a same set of spatial domain bases for each panel of a plurality of panels used to transmit the set of channel state information reference signals, or
generate the channel state information report using a same set of spatial domain bases, a same set of frequency domain bases, and a different co-phasing value for each panel of a plurality of panels used to transmit the set of channel state information reference signals.

16. (canceled)

17. The apparatus of claim 15, wherein, to transmit the channel state information report, the at least one processor is further configured to:
transmit the channel state information report via an uplink control information, wherein an indication of the set of spatial domain bases are packed in group zero of part two of the uplink control information, wherein a set of non-zero coefficients for each layer are indicated in a group one or a group two of part two of the uplink control information, and wherein a quantity of non-zero coefficients of the set of non-zero coefficients for each layer is indicated in part one of the uplink control information.

18. (canceled)

19. The apparatus of claim 15, wherein, to transmit the channel state information report, the at least one processor is further configured to:
transmit the channel state information report via an uplink control information, wherein an indication of the set of spatial domain bases are packed in group zero of part two of the uplink control information, wherein the different co-phasing value for each panel is reported in the group zero or a group one of part two of the uplink control information, wherein a set of non-zero coefficients are indicated in the group one or a group two of part two of the uplink control information, and wherein a quantity of non-zero coefficients of the set of non-zero coefficients is indicated in part one of the uplink control information.

20. The apparatus of claim 15, wherein, to generate the channel state information report in accordance with the Enhanced Type II multi-panel codebook, the at least one processor is further configured to:
generate the channel state information report using a same set of non-zero coefficients for each panel of the plurality of panels.

21. The apparatus of claim 20, wherein, to transmit the channel state information report, the at least one processor is further configured to:
transmit the channel state information report via an uplink control information, wherein an indication of the set of spatial domain bases are packed in group zero of part two of the uplink control information, wherein the different co-phasing value for each panel is reported in the group zero or a group one of part two of the uplink control information, wherein a set of non-zero coefficients are indicated in the group one or a group two of part two of the uplink control information, and wherein a quantity of non-zero coefficients of the set of non-zero coefficients is indicated in part one of the uplink control information.

22. The apparatus of claim 1, wherein the threshold is thirty-two antenna ports.

23. An apparatus for wireless communications, comprising:
memory; and
at least one processor of a network entity, the at least one processor coupled with the memory and configured to:
transmit, to a user equipment (UE), a set of channel state information reference signals using a set of antenna ports; and
receive, from the UE, a channel state information report generated at the UE in accordance with a codebook, wherein a size of a downlink channel matrix indicated by the channel state information report is based at least in part on a quantity of antenna ports that is included in the set of antenna ports used to transmit the set of channel state information reference signals, and wherein at least one parameter of the codebook is based at least in part on the quantity of antenna ports exceeding a threshold.

24.-44. (canceled)

45. A method for wireless communications at a user equipment (UE), comprising:
receiving, from a network entity, a set of channel state information reference signals from a set of antenna ports at the network entity;
generating a channel state information report in accordance with a codebook, wherein a size of a downlink channel matrix estimated based on the set of channel state information reference signals and used to generate the channel state information report is based at least in part on a quantity of antenna ports that is included in the set of antenna ports, and wherein at least one parameter of the codebook is based at least in part on the quantity of antenna ports exceeding a threshold; and
transmitting, to the network entity, the channel state information report.

46. (canceled)
